(19) United States
(12) Patent Application Publication
(10) Pub. No.: US 2012/0292865 A1
(43) Pub. Date: Nov. 22, 2012

(54) FALLING PREVENTION STRUCTURE FOR SOCKET OF POWER TOOL

(75) Inventors: Manabu Sugimoto, Anjo-shi (JP); Hidenori Nagasaka, Anjo-shi (JP); Ryunosuke Kumagai, Anjo-shi (JP)

(73) Assignee: MAKITA CORPORATION, Anjo-shi, Aichi (JP)

(21) Appl. No.: 13/574,947

(22) PCT Filed: Feb. 10, 2011
(86) PCT No.: PCT/JP2011/052824

§ 371 Date: Jul. 24, 2012

(30) Foreign Application Priority Data
Mar. 10, 2010 (JP) 2010-053613
Mar. 10, 2010 (JP) 2010-053614

(51) Int. Cl. B25F 5/00

(52) U.S. Cl. 279/142

(57) ABSTRACT

An object of the present invention is to prevent a socket from falling off by means of a simple and compact configuration without impairing comfort and ease of use, regardless of model. In an impact driver, a connecting ring in which a protrusion including a through hole protrudes from an outer periphery thereof is clamped detachably to an outer periphery of a shaft support portion of a hammer case. By a carabiner passing through a ring of a socket and the through hole in the connecting ring and engaging the carabiner, a socket portion can be prevented from falling off when a bit portion is broken.

### TECHNICAL FIELD

The present invention relates to a structure that prevents a socket mounted on an output shaft of a power tool such as an impact driver from falling off.

### BACKGROUND ART

In a power tool such as an impact driver, a socket is used as a tip end tool when a tightening operation of a bolt or a nut is performed. The socket is attached by being mounted via a drill bit or the like mounted on an output shaft that protrudes forward from a housing, or by mounting a bit portion formed integrally with the socket directly on the output shaft. In this case, a falling prevention structure such as that disclosed in Patent Document 1, for example, is employed to ensure that the socket does not fall off the power tool when the socket comes off or the bit or bit portion is broken. In this structure, a jig including a ring is attached to an outer periphery of a tool attachment portion of the socket such that the ring is connected to the power tool by an attachment tool serving as a connecting body.

### CITATION LIST

### Patent Literature

Patent Document 1: Japanese Patent Application Publication No. 2009-285756 (JP-2009-285756 A)

### SUMMARY OF THE INVENTION

### Problem to be Solved by the Invention

In the falling prevention structure described above, however, the attachment tool is attached as a strip-form body that is wound around the housing of the power tool, and therefore attachment and detachment of the strip-form body is troublesome. Further, depending on the model of the power tool, the strip-form body may block an opening provided in the housing to take in and discharge motor cooling air or the like, thereby interfering with original functions of the power tool. In such cases, the strip-form body cannot be used. Further, a surface of the housing becomes uneven due to the strip-form body, and as a result, the compactness of the power tool is impaired. Moreover, the strip-form body may cause an obstruction or catch on the surroundings during an operation, leading to deterioration of the comfort and ease of use.

An object of the present invention is therefore to provide a falling prevention structure for a socket of a power tool that can prevent the socket from falling off by means of a simple and compact configuration without impairing comfort and ease of use, regardless of the type of the power tool.

### Solution to Problem

To achieve this object, an invention described in claim 1 is a falling prevention structure for a socket of a power tool, including a power tool having an output shaft that protrudes forward from a housing, a socket mounted so as to be attached to and detached from the output shaft, and a connecting body that connects the power tool and the socket to each other so as to prevent the socket from falling, wherein a connecting member to which the connecting body can be connected is provided so as to be attached to and detached from the power tool.

According to an invention described in claim 2, in the configuration of claim 1, the connecting member is formed in a ring shape which has a connecting portion to which the connecting body is connected on an outer periphery of the connecting member.

According to an invention described in claim 3, in the configuration of claim 1 or 2, the connecting body includes at least a hook member on an end portion of the connecting member, and is connected to the connecting member by allowing the hook member to pass through and engage with the connecting member.

According to an invention described in claim 4, in the configuration of claim 1 or 2, the connecting member is provided on an outer periphery of a tubular shaft support portion that is provided on a front end of the housing to support the output shaft rotatably.

According to an invention described in claim 5, in the configuration of claim 2, the connecting member is provided such that an attachment position of the connecting member in a circumferential direction can be modified.

According to an invention described in claim 6, in the configuration of claim 2, the connecting member is a connecting ring, a part of which is separated such that respective ends of the connecting ring form a pair of clamp pieces having a predetermined interval, and the connecting ring can be attached and detached by rotating a wing bolt penetrating one of the clamp pieces so that the wing bolt is screwed to a nut fitted to the other clamp piece.

According to an invention described in claim 7, in the configuration of claim 6, a ridge is formed around an inner periphery of the connecting ring in a circumferential direction, and a recessed groove into which the ridge fits is formed in a mounting position in which the connecting ring is mounted on the power tool.

According to an invention described in claim 8, in the configuration of claim 2, the connecting portion is a protrusion in which a through hole is formed.

According to an invention described in claim 9, in the configuration of claim 2, the connecting member is a connecting ring which has a female screw portion formed in an inner periphery of the connecting ring and is mounted by screwing the female screw portion to a male screw portion provided on the power tool.

According to an invention described in claim 10, in the configuration of claim 9, a plurality of teeth is formed continuously on an outer periphery of the connecting ring.

According to an invention described in claim 11, in the configuration of claim 2, a protrusion is provided on one of an inner peripheral surface of the connecting member and an outer peripheral surface of the power tool, and an introduction groove into which the protrusion goes as the connecting member is mounted and a circumferential recessed groove that communicates with the introduction groove are provided on the other one of the inner peripheral surface of the connecting member and the outer peripheral surface of the power tool, whereby the connecting member can be attached to and detached from the power tool by a bayonet joint.

According to an invention described in claim 12, in the configuration of claim 1, a protector is mounted so as to be attached to and detached from the power tool, and a connecting portion in which the connecting body is connected to is provided on the protector such that the protector doubles as the connecting member.

### Advantageous Effects of the Invention

According to the invention described in claim 1, a function for preventing the socket from falling off can be added to the existing power tool easily without interfering with the original functions of the power tool. Further, the connecting member can be attached and detached easily and does not project much from the power tool when attached. Hence, the compactness of the power tool is not impaired, and the connecting member is not likely to cause an obstruction or catch on the surroundings. As a result, favorable comfort and ease of use can be maintained.

According to the invention described in claim 2, in addition to the effects of claim 1, the connecting member is formed in a ring shape and can therefore be attached to and detached from the power tool even more easily.

According to the invention described in claim 3, in addition to the effects of claim 1 or claim 2, the hook member is passed through and engaged, thereby improving the reliability of falling prevention.

According to the invention described in claim 4, in addition to the effects of claim 1 or claim 2, the connection with the connection body can be realized easily, and the connecting member can be disposed in an optimum position for avoiding interference with the functions of the power tool.

According to the invention described in claim 5, in addition to the effects of claim 2, the connection with the connection body can be realized in an appropriate position corresponding to a form and an operation of the power tool. As a result, a further improvement in ease of use is achieved.

### BRIEF DESCRIPTION OF THE DRAWINGS

FIG. 1 is a perspective view of an impact driver according to a first embodiment.

FIG. 2 is an illustrative view of the impact driver according to the first embodiment, wherein (A) is a side view and (B) is a front view.

FIG. 3 is a partial longitudinal sectional view of the impact driver according to the first embodiment.

FIG. 4 is a sectional view taken along an A-A line in FIG. 2.

FIG. 5 is a perspective view of an impact driver according to a second embodiment.

FIG. 6 is an illustrative view of the impact driver according to the second embodiment, wherein (A) is a side view and (B) is a front view.

FIG. 7 is a partial longitudinal sectional view of the impact driver according to the second embodiment.

FIG. 8 is a perspective view of an impact driver according to a third embodiment.

FIG. 9 is an illustrative view of the impact driver according to the third embodiment, wherein (A) is a side view and (B) is a front view.

FIG. 10 is a partial longitudinal sectional view of the impact driver according to the third embodiment.

FIG. 11 (A) is a sectional view taken along a B-B line in FIG. 9, and (B) is a sectional view taken along a C-C line in FIG. 9.

FIG. 12 is an illustrative view of an impact driver according to a fourth embodiment, wherein (A) is a partial longitudinal sectional view and (B) is a front view.

FIG. 13 is a perspective view of an impact driver according to a fifth embodiment.

FIG. 14 is a partial longitudinal sectional view of the impact driver according to the fifth embodiment.

FIG. 15 is a perspective view of an impact driver according to a sixth embodiment.

FIG. 16 is an illustrative view of the impact driver according to the sixth embodiment, wherein (A) is a side view and (B) is a front view.

FIG. 17 is a partial longitudinal sectional view of the impact driver according to the sixth embodiment.

FIG. 18 is an illustrative view of an impact driver according to a seventh embodiment, wherein (A) is a side view and (B) is a front view.

FIG. 19 is a partial longitudinal sectional view of the impact driver according to the seventh embodiment.

FIG. 20 is a sectional view taken along a D-D line in FIG. 18.

FIG. 21 is an illustrative view of an impact driver according to an eighth embodiment, wherein (A) is a side view and (B) is a front view.

FIG. 22 is a partial longitudinal sectional view of the impact driver according to the eighth embodiment.

FIG. 23 is a sectional view taken along an E-E line in FIG. 22.

FIG. 24 is an illustrative view of an impact driver according to a ninth embodiment, wherein (A) is a side view and (B) is a front view.

FIG. 25 is a partial longitudinal sectional view of the impact driver according to the ninth embodiment.

FIG. 26 is a sectional view taken along an F-F line in FIG. 24.

FIG. 27 is an illustrative view of an impact driver according to a tenth embodiment, wherein (A) is a side view and (B) is a front view.

FIG. 28 is a partial longitudinal sectional view of the impact driver according to the tenth embodiment.

FIG. 29 is a sectional view taken along a G-G line in FIG. 27.

FIG. 30 is a perspective view of an impact driver according to an eleventh embodiment.

FIG. 31 is a side view of the impact driver according to the eleventh embodiment.

FIG. 32 is a sectional view taken along an H-H line in FIG. 31.

FIG. 33 is a perspective view of an impact driver according to a twelfth embodiment.

FIG. 34 is an enlarged perspective view of a connecting protrusion part of the impact driver according to the twelfth embodiment.

FIG. 35 is a perspective view of an impact driver according to a thirteenth embodiment.

FIG. 36 is an illustrative view of the impact driver according to the thirteenth embodiment, wherein (A) is a side view and (B) is a front view.

FIG. 37 is a partial longitudinal sectional view of the impact driver according to the thirteenth embodiment.

FIG. 38 is a perspective view of an impact driver according to a fourteenth embodiment.

FIG. 39 is a longitudinal sectional view of a light unit part of the impact driver according to the fourteenth embodiment.

FIG. 40 is an illustrative view showing a modified example of a connecting body.

FIG. 41 is an illustrative view showing a state in which a socket hangs down individually.

FIG. 42 is an illustrative view showing a specific example of restricting unit

FIG. 43 is an illustrative view showing a specific example of the restricting unit.

### DESCRIPTION OF EMBODIMENTS

Embodiments of the present invention will be described below on the basis of the drawings. cl First Embodiment

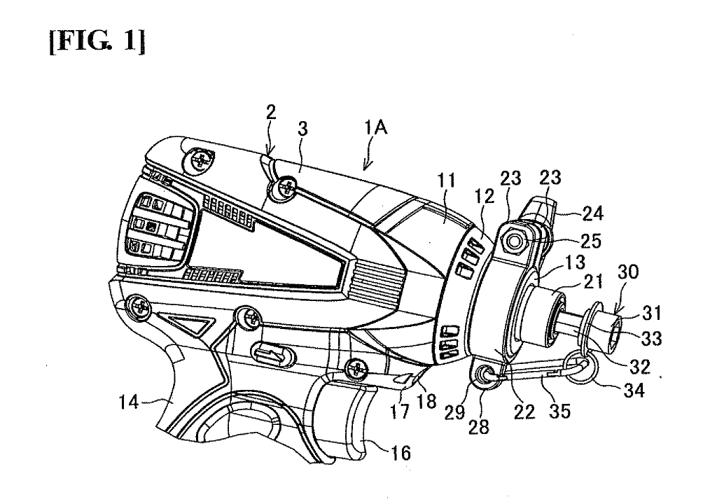

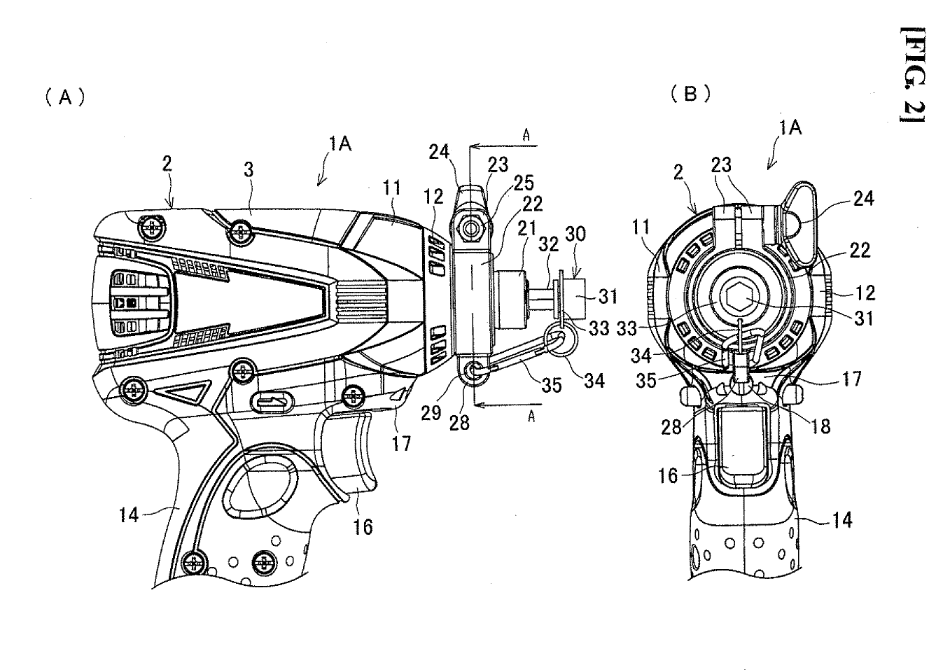

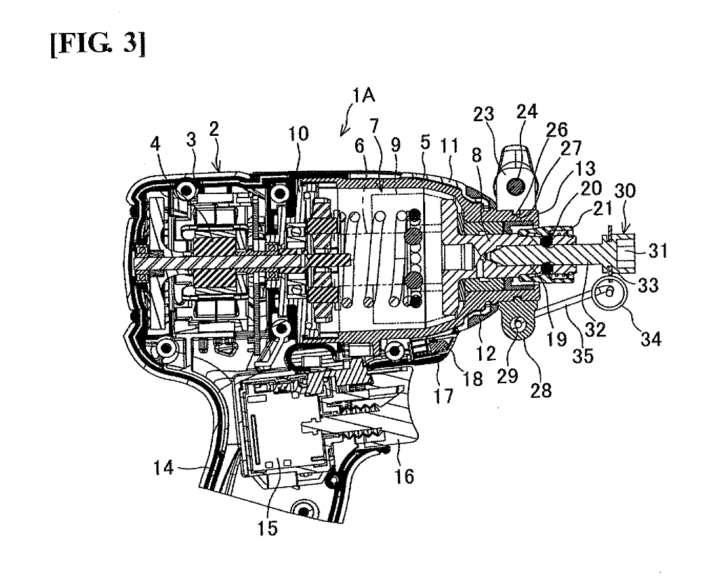

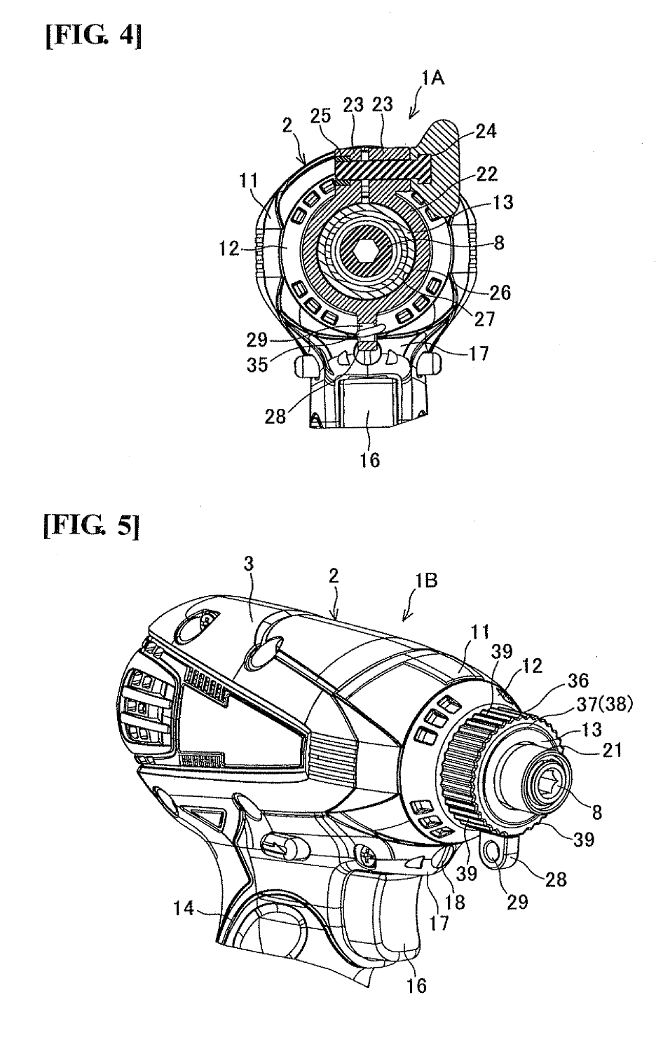

FIGS. 1 to 4 show an example of a falling prevention structure for a socket. The reference sign 1A denotes an impact driver serving as a power tool, and the impact driver 1A includes a main body housing 2 made of synthetic resin and formed by joining together left and right half housings 3 so as to accommodate a motor 4, and a metallic hammer case 5 that is joined to the front (the right side in FIG. 1) of the main body housing 2 and serves as a front side housing accommodating a spindle 6, a striking mechanism 7, and an anvil 8. The striking mechanism 7 is a conventional structure that generates an impact in a rotation direction, by repeatedly engaging and disengaging a hammer 9 to and from the anvil 8 as a load on the anvil 8 increases.

The hammer case 5 is a tubular body, a rear part of which is inserted into the main body housing 2 and screwed to a gear housing 10 in an interior thereof. A front part of the hammer case 5, which is exposed from the main body housing 2, has a forward-tapering tapered shape and is covered by a synthetic resin cover 11 and a rubber bumper 12. The anvil 8, which serves as an output shaft, protrudes forward while being supported rotatably by a shaft support portion 13 formed on a front end of the hammer case 5.

A handle 14 extends downward from a lower side of the main body housing 2, and a battery pack serving as a power supply, not shown in the drawings, is mounted on a lower end of the handle 14. A switch 15 having a trigger 16 that protrudes forward is provided in a root part of the handle 14. An extension portion 17 that covers a lower part of the hammer case 5 is formed on the main body housing 2 between the trigger 16 and the lower part of the hammer case 5, and a light unit (an LED and a substrate) 18 that illuminates a location in front of the anvil 8 is incorporated into an interior front portion of the extension portion 17.

Meanwhile, a mounting hole 19 for a drill bit or the like is formed in a front end of the anvil 8, and a chuck mechanism having a ball 20, a sleeve 21, and so on is provided on the front end of the anvil 8 to retain the drill bit or the like inserted into the mounting hole 19.

Further, a connecting ring 22 serving as a connecting member is mounted on a front part of the bumper 12 in the shaft support portion 13 of the hammer case 5. The connecting ring 22 is formed in a ring shape in which an upper side is separated to form a pair of clamp pieces 23 having a predetermined interval, and a wing bolt 24 that penetrates one of the clamp pieces 23 from an outer side is screwed to a nut 25 fitted to the other clamp piece 23. Further, a ridge 26 is provided to project from an inner periphery of the connecting ring 22 in a circumferential direction, and a recessed groove 27 into which the ridge 26 fits is provided around an outer periphery of the shaft support portion 13 in a mounting position of the connecting ring 22.

Hence, when the wing bolt 24 is tightened such that the interval between the clamp pieces 23 narrows, an inner diameter of the connecting ring 22 decreases, and conversely, when the wing bolt 24 is loosened such that the interval between the clamp pieces 23 widens, the inner diameter of the connecting ring 22 increases.

Meanwhile, a protrusion 28 serving as a connecting portion in which a lateral through hole 29 is formed protrudes downward from an outer periphery of a lower portion of the connecting ring 22 on an opposite side of the connecting ring 22 from the clamp pieces 23.

The reference numeral 30 denotes a socket that is mounted on the anvil 8 and constituted by a socket portion 31 to which a bolt and a nut can be fitted and a bit portion 32 formed identically to a drill bit or the like. A ring-shaped connecting plate 33 to which a ring 34 is attached is mounted rearward of the socket portion 31 to be capable of rotating independently of the socket portion 31.

In the impact driver IA configured as described above, when the wing bolt 24 is tightened in a mounting position where the connecting ring 22 is externally mounted on the shaft support portion 13 such that the ridge 26 is fitted into the recessed groove 27, the inner diameter of the connecting ring 22 decreases, as noted above. As a result, the connecting ring 22 is clamped to the shaft support portion 13 so as to be retained by the fit between the ridge 26 and the recessed groove 27. The bit portion 32 of the socket 30 is then inserted into the mounting hole 19 in the anvil 8, whereby the socket 30 is mounted so as to be retained by the chuck mechanism in a similar manner to a normal drill bit or the like. In this state, a carabiner 35 serving as a connecting body (a hook member) is passed through and engaged with the ring 34 of the socket 30 and the through hole 29 in the connecting ring 22, and as a result, the socket portion 31 is connected to the connecting ring 22 via the carabiner 35.

Hence, even when the bit portion 32 is broken during a tightening operation of a bolt or a nut by the socket 30, the socket portion 31 simply hangs down from the connecting ring 22 via the carabiner 35 and does not fall off the impact driver 1A.

It should be noted that in order to change the connecting position of the carabiner 35, the clamp may be released by loosening the wing bolt 24 so that the inner diameter of the connecting ring 22 is widen, as described above. In so doing, the connecting ring 22 can be rotated about the shaft support portion 13, and therefore the protrusion 28 can be adjusted to a desired phase. Then, the wing bolt 24 is tightened again. Further, when the socket 30 is not in use, the connecting ring 22 may be detached from the shaft support portion 13 by loosening the wing bolt 24 so as to widen the inner diameter of the connecting ring 22.

In the falling prevention structure according to the first embodiment, a function for preventing the socket 30 from falling off can be fulfilled in the existing impact driver 1A without interfering with the original functions of the impact driver 1A, simply by providing the connecting ring 22, to which the carabiner 35 can be connected, detachably on the impact driver 1A. Further, the connecting ring 22 can be attached and detached easily and does not project much from the impact driver 1A when attached. Hence, the compactness of the impact driver 1A is not impaired, and the connecting ring 22 is not likely to cause an obstruction or catch on the surroundings. As a result, favorable comfort and ease of use can be maintained.

In this case in particular, the connecting member is constituted by the connecting ring 22 having the protrusion 28 to which the carabiner 35 is connected on the outer periphery thereof, and therefore the connecting ring 22 can be fitted to the shaft support portion 13 easily, leading to further simplification of the operation for attaching and detaching the connecting ring 22 to and from the impact driver 1A.

Further, the connecting body is the carabiner 35 serving as the hook member, and the connecting body is connected to the connecting ring 22 by allowing the carabiner 35 to pass through and engage with the connecting ring 22. As a result, the reliability of the falling prevention function is improved.

Moreover, the connecting ring 22 is provided on the outer periphery of the tubular shaft support portion 13 formed on the front end of the hammer case 5 to rotatably support the anvil 8. Therefore, the connecting ring 22 can be disposed in an optimum position where connection to the carabiner 35 is easy and interference with the functions of the impact driver 1A does not occur.

Furthermore, the connecting ring 22 is provided such that the attachment position thereof in the circumferential direction can be modified, and therefore the connecting ring 22 can be connected to the carabiner 35 in an appropriate position corresponding to a form and an operation of the impact driver 1A. As a result, a further improvement in ease of use is achieved.

It should be noted that in the first embodiment, a form of the connecting ring, a length of the protrusion, a size and an orientation of the through hole, and so on are not limited to the content described above, and appropriate modifications such as shortening the clamp pieces, increasing the size of the through hole, and changing the orientation of the through hole to a front-rear direction may be applied. Further, the positions of the ridge and the recessed groove may be reversed such that the ridge is provided on the shaft support portion and the recessed groove is provided in the connecting ring.

Next, other embodiments will be described. It should be noted that identical constituent portions to those of the first embodiment, such as the structure of the impact driver, have been allocated identical reference numerals, and duplicate description thereof has been omitted.

### Second Embodiment

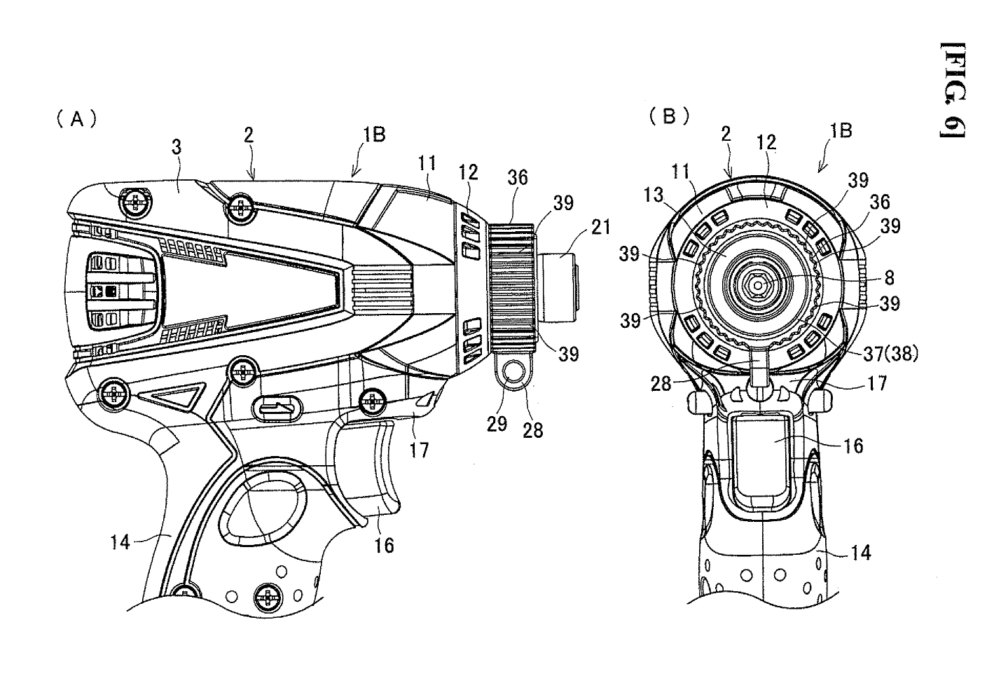

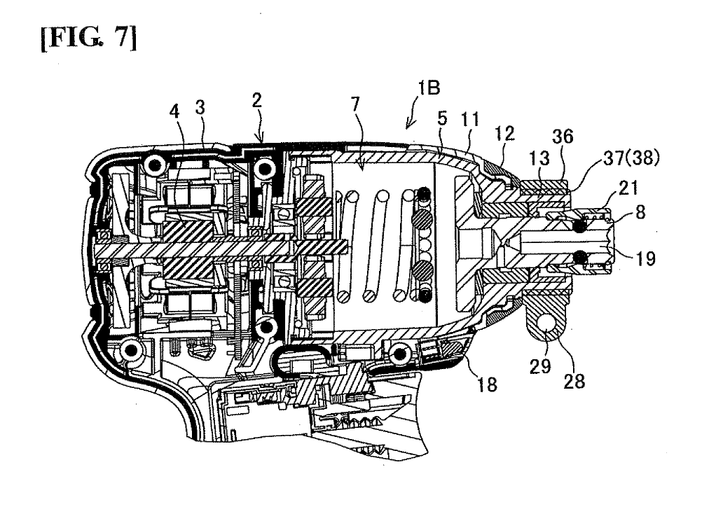

In an impact driver 1B shown in FIGS. 5 to 7, a connecting ring 36 serving as the connecting member is a ring body having an entirely joined periphery. Here, a female screw portion 37 is formed in an inner periphery of the connecting ring 36, and the connecting ring 36 is mounted on the shaft support portion 13 detachably by screwing the female screw portion 37 to a male screw portion 38 provided on the outer periphery of the shaft support portion 13. The protrusion 28 and the through hole 29 are provided identically to the first embodiment. Further, a plurality of teeth 39 are formed continuously on the outer periphery of the connecting ring 36 to facilitate fastening and detachment of the connecting ring 36 to and from the shaft support portion 13.

In the second embodiment, when the connecting ring 36 is screwed and fastened to the shaft support portion 13, the connecting ring 36 is joined to the shaft support portion 13 integrally. When, in this state, the carabiner 35 is passed through and engaged with the ring 34 of the socket 30 and the through hole 29 in the connecting ring 36, the socket portion 31 is connected to the connecting ring 36 via the carabiner 35.

Hence, even when the bit portion 32 is broken during a tightening operation of a bolt or a nut by the socket 30, the socket portion 31 simply hangs down from the connecting ring 36 via the carabiner 35 and does not fall off the impact driver 1B.

It should be noted that when the socket 30 is not in use, the connecting ring 36 may be detached from the shaft support portion 13 by loosening the fastening of the connecting ring 36.

Therefore, likewise in the falling prevention structure according to the second embodiment, a function for preventing the socket 30 from falling off can be fulfilled in the existing impact driver 1B simply by providing the connecting ring 36, to which the carabiner 35 can be connected, detachably on the impact driver 1B. Further, the connecting ring 36 can be attached and detached easily and does not project much from the impact driver 1B when attached. Hence, the compactness of the impact driver 1B is not impaired, and the connecting ring 36 is not likely to cause an obstruction or catch on the surroundings. As a result, favorable comfort and ease of use can be maintained.

Further, by employing the connecting ring 36 that is mounted by screwing, similarly to the first embodiment, facilitating the operations to attach and detach the connecting ring 36 to and from the impact driver 1B is effectively realized. Further, the reliability with which allowing the carabiner 35 to pass through and engage prevents the socket from falling off can be improved, and the connecting ring 36 can be provided in an optimum position on the outer periphery of the shaft support portion 13.

Moreover, in the second embodiment, in contrast to the first embodiment, the clamp pieces and the wing bolt do not project from the connecting ring 36, and therefore the connecting ring 36 is favorably provided on the impact driver 1B when attached. As a result, the impact driver 1B exhibits superior compactness.

It should be noted that likewise in the second embodiment, the form of the connecting ring may be modified appropriately. For example, instead of providing teeth on the outer periphery of the connecting ring, the outer periphery may be knurled. Alternatively, such surface processing may be omitted, and instead, the connecting ring may be formed with a polygonal outer shape such as a hexagonal outer shape or the like. Needless to mention, the size and orientation of the through hole as well as the length of a protruding portion may also be modified.

### Third Embodiment

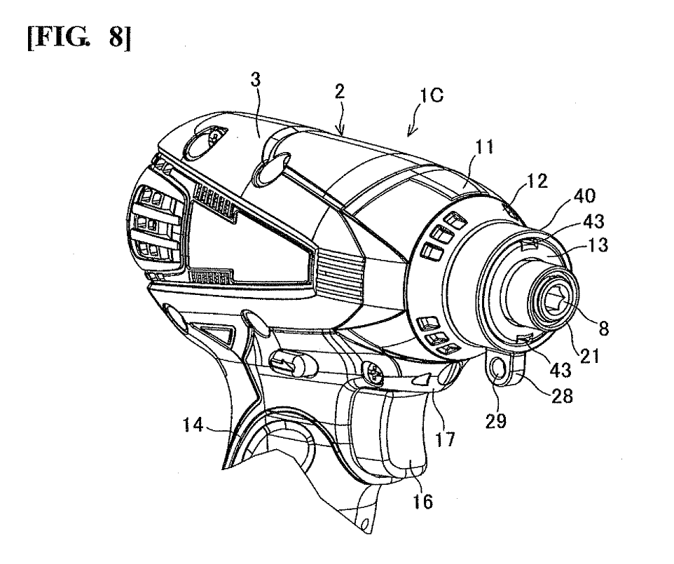

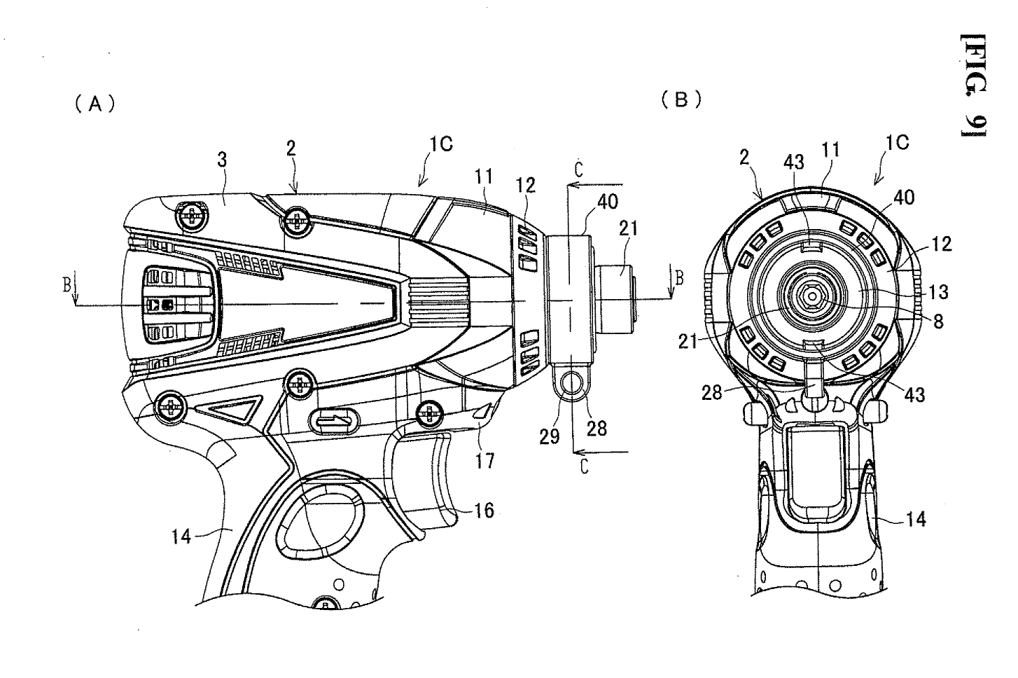

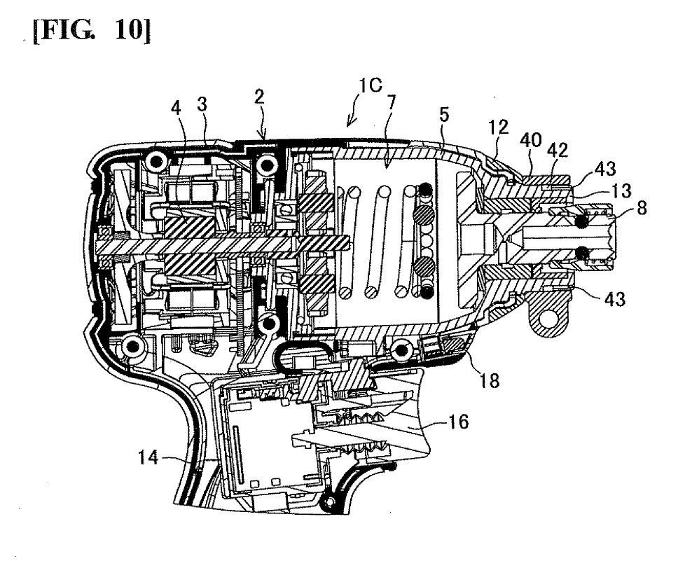

In an impact driver 1C shown in FIGS. 8 to 11, a connecting ring 40 serving as the connecting member is attached by a bayonet joint.

A pair of protrusions 41 project from an inner peripheral surface of the connecting ring 40, which is constituted by a ring body having an entirely connected periphery, in point symmetrical positions. Meanwhile, a recessed groove 42 is provided around an outer peripheral surface of the shaft support portion 13 in a circumferential direction, and a pair of introduction grooves 43 extend in an axial direction up to a front end of the shaft support portion 13 in point symmetrical positions so as to communicate with the recessed groove 42.

In the third embodiment, the connecting ring 40 is mounted externally from the front end of the shaft support portion 13 by aligning a phase of the protrusions 41 with the introduction grooves 43. When the protrusions 41 reach the recessed groove 42, the connecting ring 40 is rotated in the circumferential direction, whereby the connecting ring 40 is mounted such that the protrusions 41 are retained by the recessed groove 42. When, in this state, the carabiner 35 is passed through and engaged with the ring 34 of the socket 30 and the through hole 29 in the connecting ring 40, the socket portion 31 is connected to the connecting ring 40 via the carabiner 35.

Hence, even when the bit portion 32 is broken during a tightening operation of a bolt or a nut by the socket 30, the socket portion 31 simply hangs down from the connecting ring 40 via the carabiner 35 and does not fall off the impact driver 1C.

It should be noted that when the socket 30 is not in use, the connecting ring 40 may be pulled off forward by rotating the connecting ring 40 such that the phase of the protrusions 41 is aligned with the introduction grooves 43.

Therefore, likewise in the falling prevention structure according to the third embodiment, a function for preventing the socket 30 from falling off can be fulfilled to the existing impact driver 1C simply by providing the connecting ring 40, to which the carabiner 35 can be connected, detachably on the impact driver 1C. Further, the connecting ring 40 can be attached and detached easily and does not project much from the impact driver 1C when attached. Hence, the compactness of the impact driver 1C is not impaired, and the connecting ring 40 is not likely to cause an obstruction or catch on the surroundings. As a result, favorable comfort and ease of use can be maintained.

Further, by employing the connecting ring 40 that is mounted by a bayonet joint, similarly to the first embodiment, facilitating the operations to attach and detach the connecting ring 40 to and from the impact driver 1C is effectively realized. Further, the reliability with which allowing the carabiner 35 to pass through and engage prevents the socket from falling off can be improved, and the connecting ring 40 is provided in an optimum position on the outer periphery of the shaft support portion 13 can be realized.

Moreover, in the third embodiment, in contrast to the first embodiment, the clamp pieces and the wing bolt do not project from the connecting ring 40, and therefore the connecting ring 40 is favorably accommodated on the impact driver 1C when attached. As a result, the impact driver 1C exhibits superior compactness.

It should be noted that in the third embodiment, instead of providing the recessed groove around the entire periphery of the shaft support portion, short, L-shaped grooves are provided for and connected to the respective introduction grooves, for example. Further, the positions of the protrusions and the grooves may be reversed such that the protrusions are provided on the outer peripheral surface of the shaft support portion and the grooves are provided in the inner peripheral surface of the connecting ring.

### Fourth Embodiment

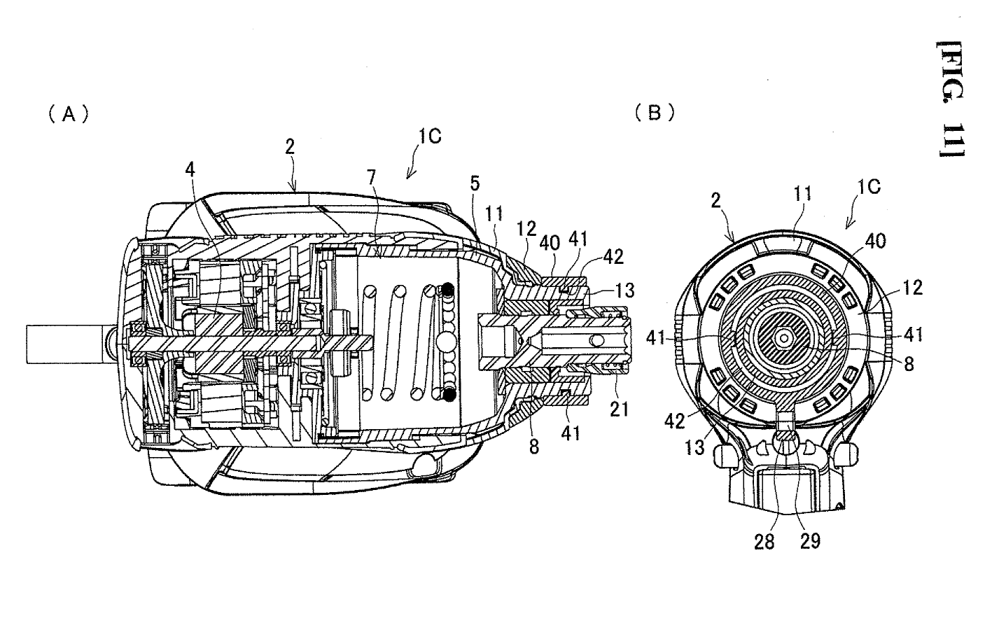

In an impact driver 1D shown in FIG. 12, a rubber protector 44 is mounted detachably to extend over substantially the entirety of the hammer case 5 and the main body housing 2 from the rear of the bumper 12 in place of the cover. The protector 44 covers the hammer case 5 and so on in order to prevent damage to a processed material or the like when the impact driver 1D contacts the processed material or the like, discomfort caused when an operator grips the hammer case 5 or the like directly while a temperature of the hammer case 5 or the like is high during use, and so on. Here, on the other hand, a protrusion 45 formed with a through hole 46 is formed integrally with the protector 44 to project from a front end of an upper surface thereof. In other words, the existing protector 44 doubles as the connecting member.

In the fourth embodiment, when the protector 44 is attached and the carabiner 35 is passed through and engaged with the ring 34 of the socket 30 and the through hole 46 in the protector 44, the socket portion 31 is connected to the protector 44 via the carabiner 35.

Hence, even when the bit portion 32 is broken during a tightening operation of a bolt or a nut by the socket 30, the socket portion 31 simply hangs down from the protector 44 via the carabiner 35 and does not fall off the impact driver 1D.

Therefore, likewise in the falling prevention structure according to the fourth embodiment, a function for preventing the socket 30 from falling off can be fulfilled in the existing impact driver 1D simply by providing the protector 44, to which the carabiner 35 can be connected, detachably on the impact driver 1D. Further, the protector 44 can be attached and detached easily and does not project much from the impact driver 1D when attached. Hence, the compactness of the impact driver 1D is not impaired, and the protector 44 is not likely to cause an obstruction or catch on the surroundings. As a result, favorable comfort and ease of use can be maintained.

Here in particular, an effective configuration in which the existing protector 44 doubles as the connecting member is employed, which is advantageous in terms of cost in comparison with a case where a new connecting member is provided.

It should be noted that in the fourth embodiment, the position of the protrusion is not limited to the front end of the upper surface of the protector, and depending on the form of the housing and the protector, the protrusion may be provided on a side face or a lower surface. Further, the orientation of the protrusion and the through hole may be modified appropriately.

Furthermore, in all of the first to fourth embodiments, the connecting member may be modified appropriately so that instead of the clamp, screw, and bayonet joint described above, a screw portion is provided on the connecting member having the through hole to which the connecting body is connected, and the screw portion is attached and detached by being screwed into a screw hole formed in the housing, for example.

### Fifth Embodiment

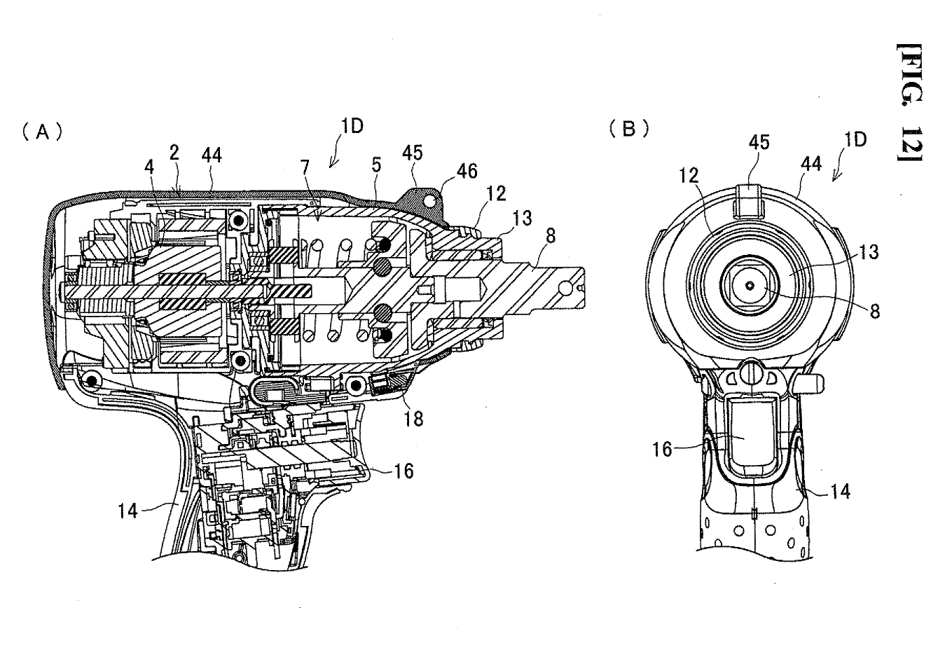

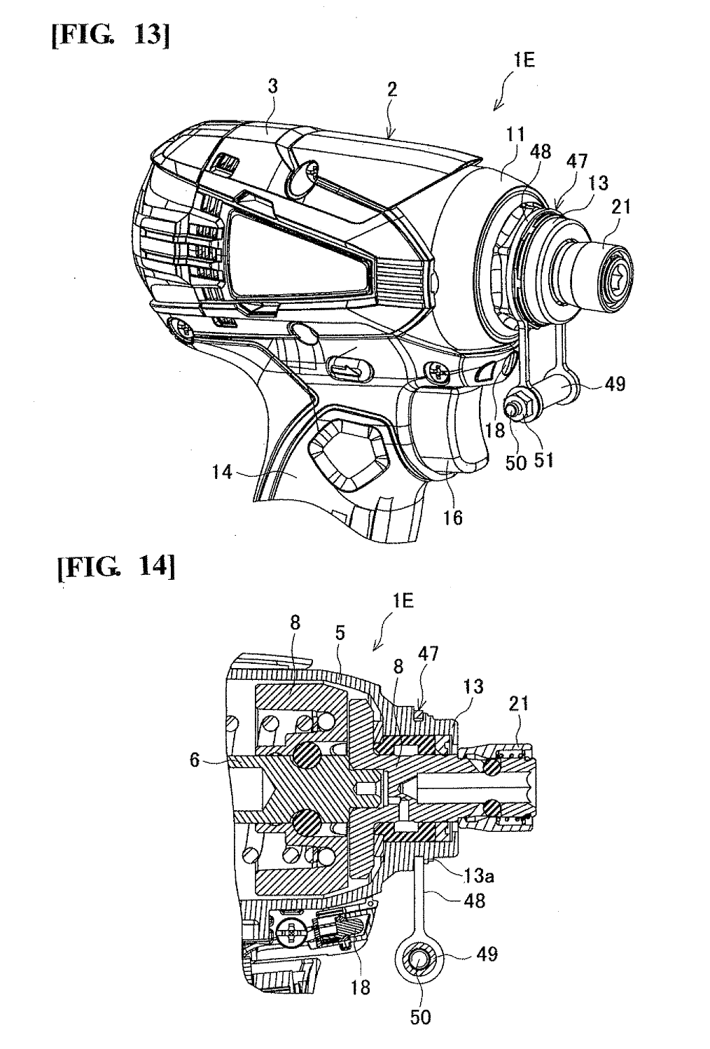

In an impact driver 1E shown in FIGS. 13 and 14, a connecting band 47 serving as the connecting member is connected to the outer periphery of the shaft support portion 13 in a state where the bumper 12 is removed. The connecting band 47 is constituted by an inverted U-shaped band body 48 and a hollow connecting rod 49. The inverted U-shaped band body 48 is made of synthetic resin, which is engaged from an upper side to an engaging groove 13a for engaging the bumper 12. The bumper 12 is provided around the outer periphery of the shaft support portion 13 such that respective ends of the band body 48 hang downward. The hollow connecting rod 49 is provided to extend between lower ends of the band body 48 in a left-right direction and fastened by a bolt 50 and a nut 51.

In the fifth embodiment, when the band body 48 of the connecting band 47 is engaged from above with the engaging groove 13a of the shaft support portion 13, which is exposed after the bumper 12 is removed, the connecting rod 49 is suspended below the shaft support portion 13. When, in this state, the carabiner 35 is passed through and engaged with the ring 34 of the socket 30 and the connecting rod 49, the socket portion 31 is connected to the connecting band 47 via the carabiner 35.

Hence, even when the bit portion 32 is broken during a tightening operation of a bolt or a nut by the socket 30, the socket portion 31 simply hangs down from the connecting band 47 via the carabiner 35 and does not fall off the impact driver 1E.

Therefore, likewise in the falling prevention structure according to the fifth embodiment, a function for preventing the socket 30 from falling off can be fulfilled to the existing impact driver 1E simply by providing the connecting band 47, to which the carabiner 35 can be connected, detachably on the impact driver 1E. Further, the connecting band 47 can be attached and detached easily and does not project much to the upper side and the left and right sides of the impact driver 1E when attached. Hence, the compactness of the impact driver 1E is not impaired, and the connecting band 47 is not likely to cause an obstruction or catch on the surroundings. As a result, favorable comfort and ease of use can be maintained.

It should be noted that in the fifth embodiment, the connecting rod may be connected to the band body by joining unit other than a bolt, such as a rivet or welding. Moreover, the connecting rod may be formed integrally with the band body rather than being provided separately. Further, the connection between the connecting band and the impact driver is not limited to a structure using the engaging groove, and may be modified appropriately by, for example, externally attaching the band body to the cover or the outer periphery of the bumper without removing the bumper, or the like.

### Sixth Embodiment

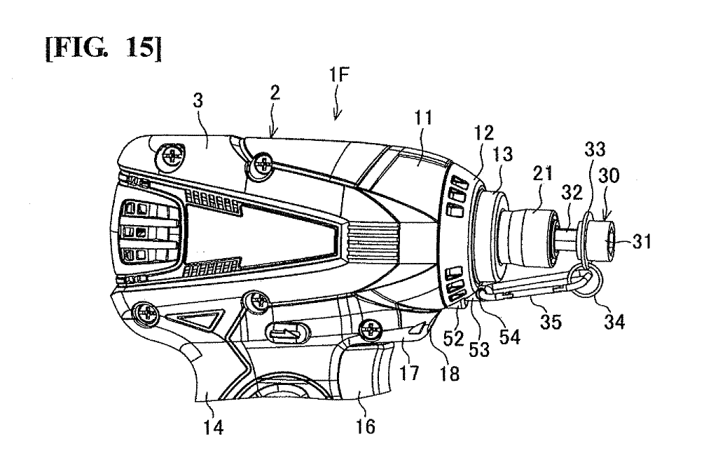

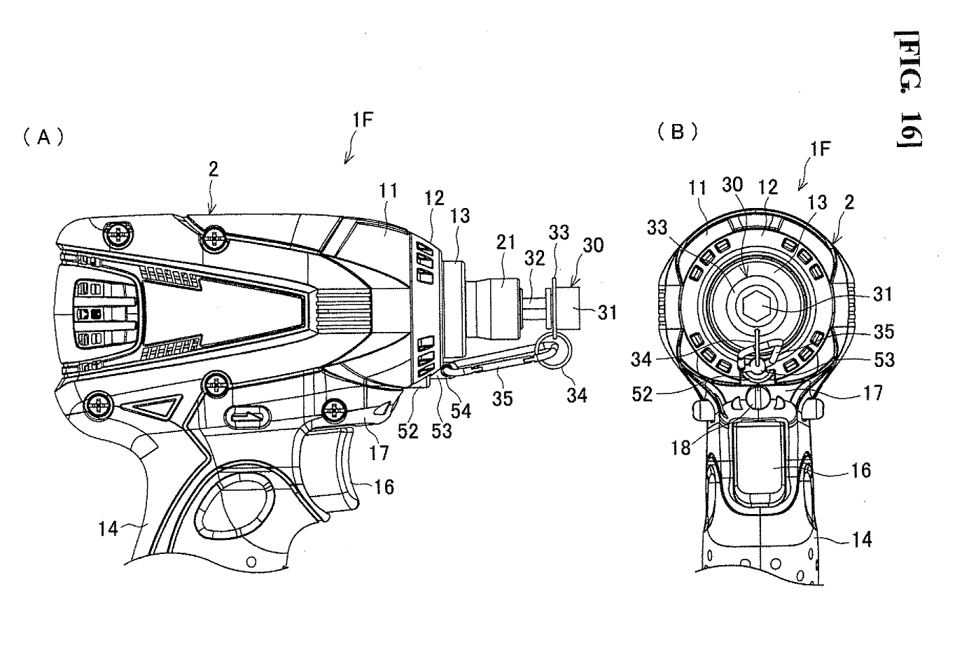

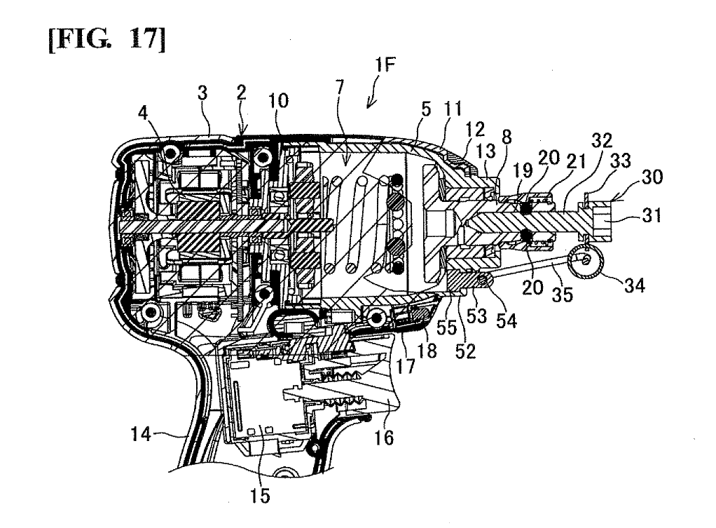

In an impact driver 1F shown in FIGS. 15 to 17, a columnar boss portion 52 is formed integrally with a lower portion of the shaft support portion 13 in the hammer case 5, and a connecting pin 53 is provided in the boss portion 52. A lateral through hole 54 and a large diameter retaining portion 55 are formed on a front end and a rear end of the connecting pin 53, respectively. By inserting the connecting pin 53 into the boss portion 52 from an inner side of the hammer case 5, the retaining portion 55 is press-fitted into the boss portion 52. The connecting pin 53 is mounted such that the through hole 54 protrudes forward from the boss portion 52. The through hole 54 is positioned below an axial center of the anvil 8 and forward of the striking mechanism 7.

In the sixth embodiment, the bit portion 32 of the socket 30 is inserted into the mounting hole 19 in the anvil 8, whereby the socket 30 can be mounted so as to be retained by the chuck mechanism in a similar manner to a normal drill bit or the like. When the carabiner 35 is then engaged between the ring 34 of the socket 30 and the through hole 54 in the connecting pin 53 of the hammer case IF, the socket portion 31 is connected to the connecting pin 53 via the carabiner 35.

Hence, even when the bit portion 32 is broken during a tightening operation of a bolt or a nut by the socket 30, the socket portion 31 simply hangs down from the connecting pin 53 via the carabiner 35 and does not fall off the impact driver 1F.

Therefore, by providing the connecting pin 53 including the through hole 54, to which the carabiner 35 is connected, integrally with the impact driver 1F in the falling prevention structure according to the sixth embodiment, the labor involved in attaching and detaching a connecting member such as a strip-form body can be eliminated, and as a result, the socket 30 can be prevented from falling off easily without interfering with the functions of the impact driver 1F. Further, the connecting pin 53 does not project much from the impact driver 1F, and therefore the compactness of the impact driver 1F is not impaired and the connecting pin 53 is not likely to cause an obstruction or catch on the surroundings. As a result, favorable comfort and ease of use can be maintained.

In this case in particular, the through hole 54 is used as the connecting portion to which the carabiner 35 is engaged, and therefore the carabiner 35 is unlikely to become detached, leading to an improvement in the reliability with which falling is prevented.

Furthermore, by incorporating the separate connecting pin 53 including the through hole 54 into the impact driver 1F, a degree of freedom in the material, form, and so on of the connecting pin 53 can be improved, and therefore the connecting pin 53 that is most suitable for the impact driver 1F can be selected.

Moreover, the through hole 54 in the connecting pin 53 is disposed in front of the striking mechanism 7 and in or below the axial center of the anvil 8, and therefore the through hole 54 can be disposed in an optimum position that does not affect the functions of the impact driver 1F.

It should be noted that in the sixth embodiment, the length of the connecting pin, the size and orientation of the through hole, the structure for incorporating the connecting pin into the impact driver, and so on are not limited to those of the sixth embodiment, and appropriate modifications such as increasing the size of the through hole part, changing the orientation of the through hole to an up-down direction or a diagonal direction, screwing the connecting pin to a female screw portion provided in the hammer case, and press-fitting the connecting pin into a closed-end hole provided in the hammer case may be applied.

Further, although the connecting pin is preferably positioned in front of the striking mechanism and in or below the axial center of the anvil, the connecting pin may be provided above the anvil instead.

### Seventh Embodiment

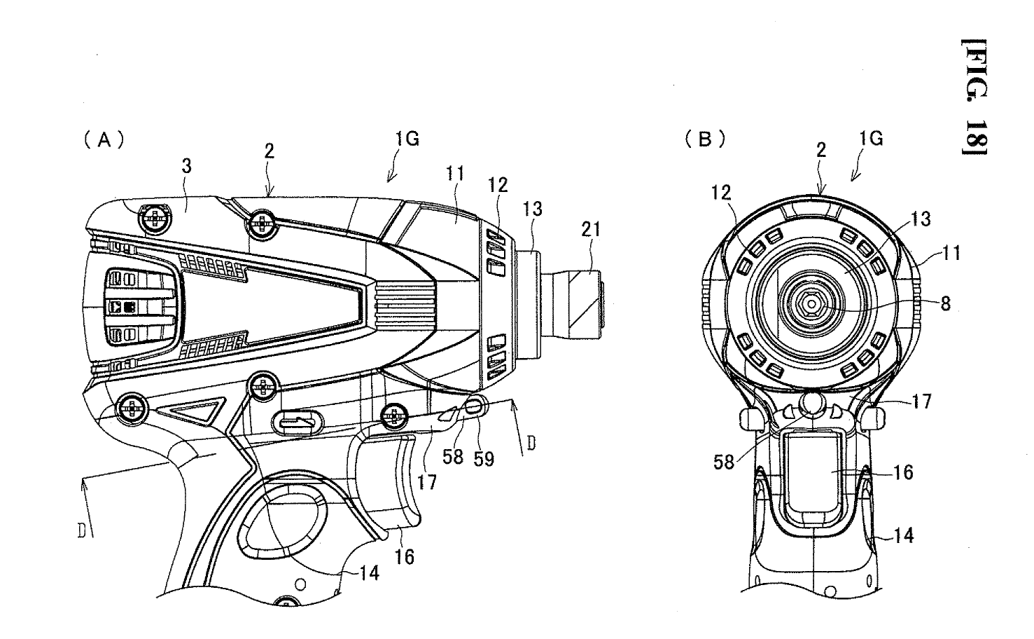

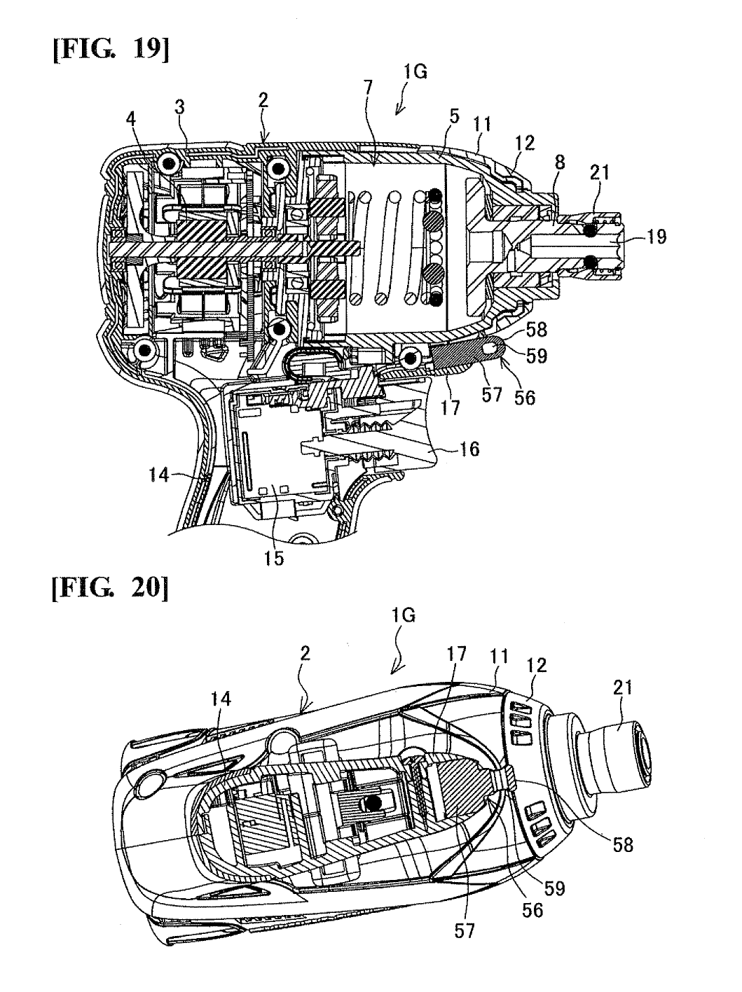

In an impact driver 1G shown in FIGS. 18 to 20, a connecting block 56 is incorporated into the extension portion 17 instead of the light unit. The connecting block 56 is constituted by a block main body 57 held on a front end of the extension portion 17 and a projecting portion 58 that protrudes from a front end of the block main body 57. When the connecting block 56 is installed into the extension portion 17, the projecting portion 58 protrudes diagonally forward from the extension portion 17. A through hole 59 is formed laterally in a front end of the projecting portion 58.

Hence, likewise in the seventh embodiment, when the carabiner 35 is engaged between the ring 34 of the socket 30 and the through hole 59 in the projecting portion 58, the socket portion 31 is connected to the projecting portion 58 via the carabiner 35. Therefore, the socket portion 31 does not fall off the impact driver 1G even when the bit portion 32 is broken during a tightening operation of a bolt or a nut.

By providing the connecting block 56 including the through hole 59, to which the carabiner 35 is connected, integrally with the impact driver 1G in the falling prevention structure according to the seventh embodiment, the labor involved in attaching and detaching a connecting member can be eliminated, similarly to the sixth embodiment, and as a result, the socket 30 can be easily prevented from falling off. Further, the compactness of the impact driver 1G is not impaired and the projecting portion 58 is not likely to cause an obstruction or catch on the surroundings. As a result, favorable comfort and ease of use can be maintained. Furthermore, similar effects to those of the sixth embodiment, namely an improvement in the reliability of falling prevention by using the through hole 59 as the connecting portion, the ability to select an optimum form of the connecting block 56 by installing the connecting block 56 separately, the ability to dispose the connecting hole 59 in an optimum position in or below the axial center of the anvil 8 and in front of the striking mechanism 7, are obtained.

In addition, in the seventh embodiment, the connecting block 56 is provided as a replacement for the light unit. Therefore, the connecting portion can be employed easily and at low cost without the need to apply design modifications to the hammer case 5, the main body housing 2, and so on.

It should be noted that the form of the connecting block may be modified appropriately likewise in the seventh embodiment by altering the length of the projecting portion and the size and orientation of the through hole.

### Eighth Embodiment

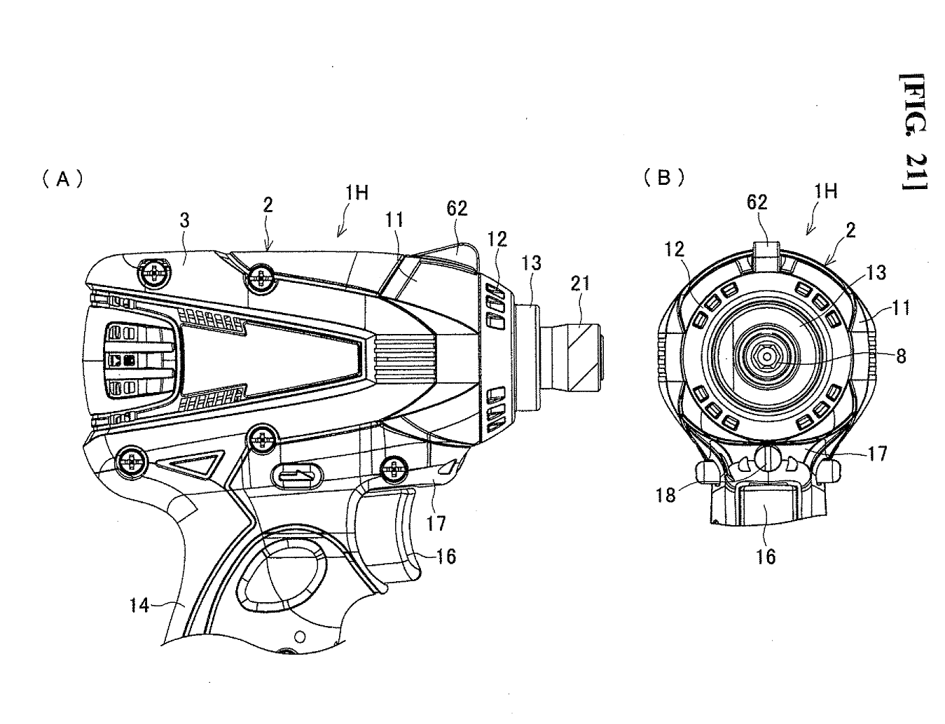

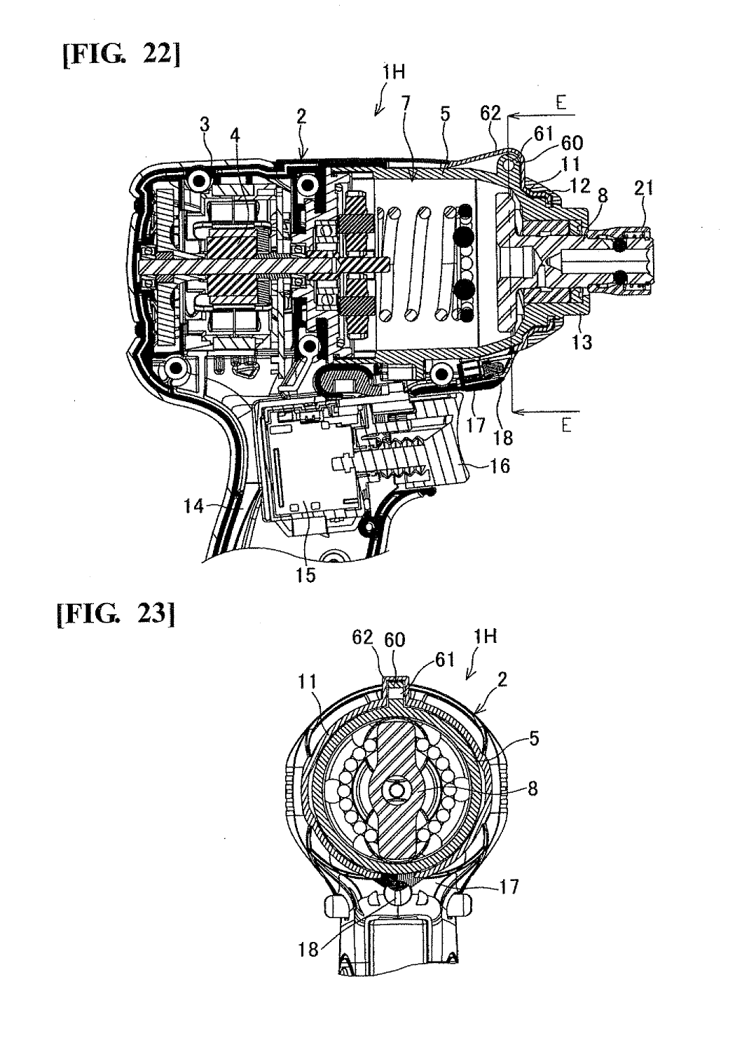

In an impact driver 1H shown in FIGS. 21 to 23, a connecting protrusion 60 formed with a lateral through hole 61 is formed rearward of the shaft support portion 13 and is formed in an upward orientation integrally with the upper surface of the hammer case 5, and a projecting portion 62 covering the connecting protrusion 60 is formed on the cover 11. Here, the cover 11 can be removed in a forward direction after removing the bumper 12 in a forward direction. Therefore, when the socket 30 is to be used, the connecting protrusion 60 can be exposed by removing the cover 11. Hence, when the carabiner 35 is engaged between the through hole 61 and the ring 34 of the socket 30, the socket 30 is connected to the connecting protrusion 60. Therefore, the socket portion 31 does not fall off the impact driver 1H even when the bit portion 32 is broken during a tightening operation of a bolt or a nut.

By providing the connecting protrusion 60 including the through hole 61, to which the carabiner 35 is connected, integrally with the impact driver 1H in the falling prevention structure according to the eighth embodiment, the labor involved in attaching and detaching a connecting member can be eliminated, similarly to the sixth embodiment. As a result, the socket 30 can be prevented from falling off easily. Further, the compactness of the impact driver 1H is not impaired and the connecting protrusion 60 is not likely to cause an obstruction or catch on the surroundings. As a result, favorable comfort and ease of use can be maintained. Furthermore, by using the through hole 61 as the connecting portion, an improvement in the reliability of falling prevention can be obtained in a similar manner to the sixth embodiment.

It should be noted that likewise in the eighth embodiment, the position, size, and so on of the connecting protrusion may be modified appropriately. For example, the connecting protrusion may be provided on the side face of the hammer case or the shaft support portion or, as in the sixth and seventh embodiments, in or below the axial center of the anvil and in front of the striking mechanism. Further, a through hole may be formed in the cover instead of the projecting portion so that the connecting protrusion can be exposed without removing the cover.

### Ninth Embodiment

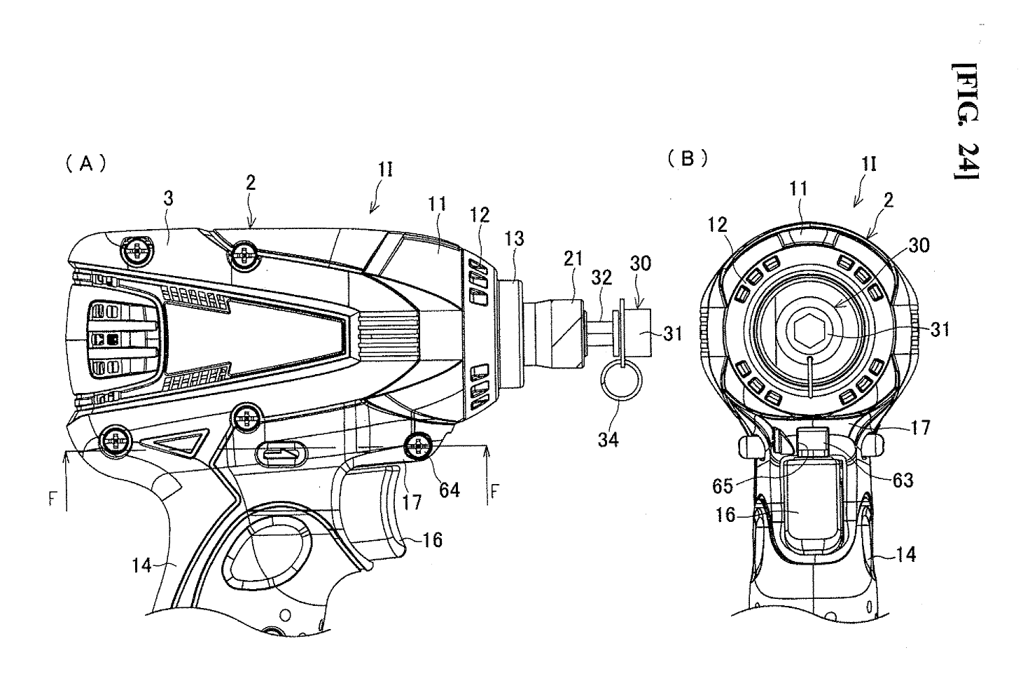

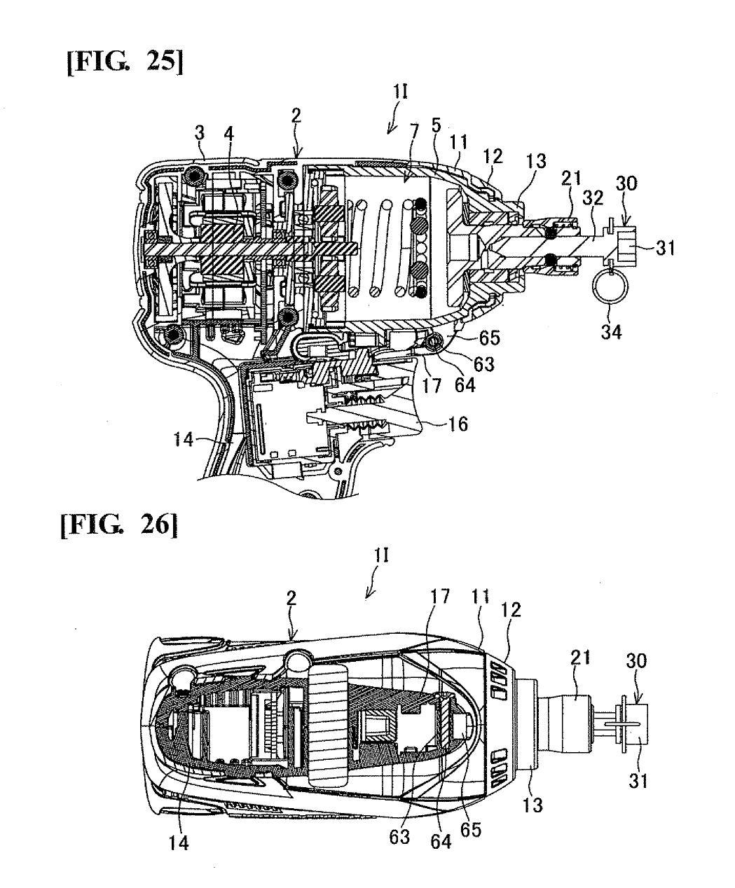

In an impact driver 1I shown in FIGS. 24 to 26, the light unit is not provided in the extension portion 17, a screw boss 63 that joins together the left and right half housings 3 forming the extension portion 17 with a screw 64 is provided at a front end part of the extension portion 17. A cutout 65 is provided to extend from a front surface to a lower surface of the extension portion 17 such that an intermediate portion of the screw boss 63 is exposed around its entire periphery. In other words, the shaft-form screw boss 63 is used as the connecting portion.

Hence, when the carabiner 35 is engaged between the ring 34 of the socket 30 and the screw boss 63, the socket portion 31 is connected to the screw boss 63 via the carabiner 35. Therefore, the socket portion 31 does not fall off the impact driver 1I even when the bit portion 32 is broken during a tightening operation of a bolt or a nut.

By providing the screw boss 63, to which the carabiner 35 is connected, integrally with the impact driver 1I in the falling prevention structure according to the ninth embodiment, the labor involved in attaching and detaching a connecting member can be eliminated, similarly to the sixth embodiment. As a result, the socket 30 can be prevented from falling off easily. Further, the compactness of the impact driver 1I is not impaired and the screw boss 63 is not likely to cause an obstruction or catch on the surroundings. As a result, favorable comfort and ease of use can be maintained.

Moreover, the connecting portion is formed from a shaft (the screw boss 63) with which the carabiner 35 is engaged. Therefore, an improvement in reliability of falling prevention is achieved when the carabiner 35 is engaged. In particular, by employing the screw boss 63 into which the screw 64 is inserted, a rigid shaft is obtained.

It should be noted that in the ninth embodiment, the position of the screw boss is not limited to the extension portion. If the housing is formed to have a screw boss on an upper side, the screw boss on the upper side may be used as the connecting portion.

### Tenth Embodiment

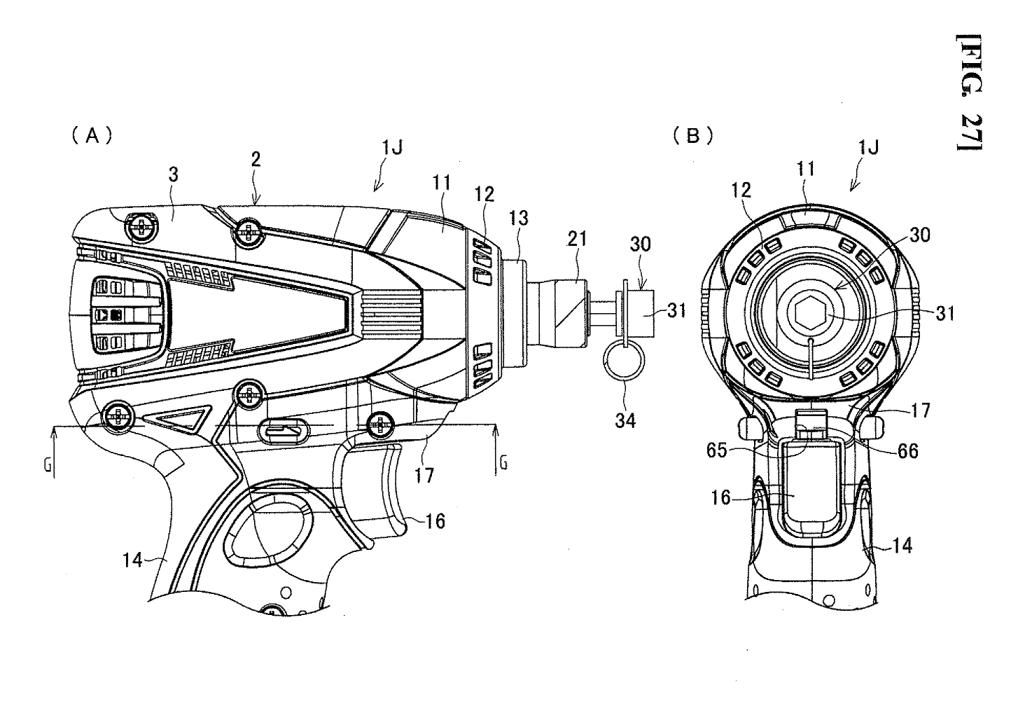

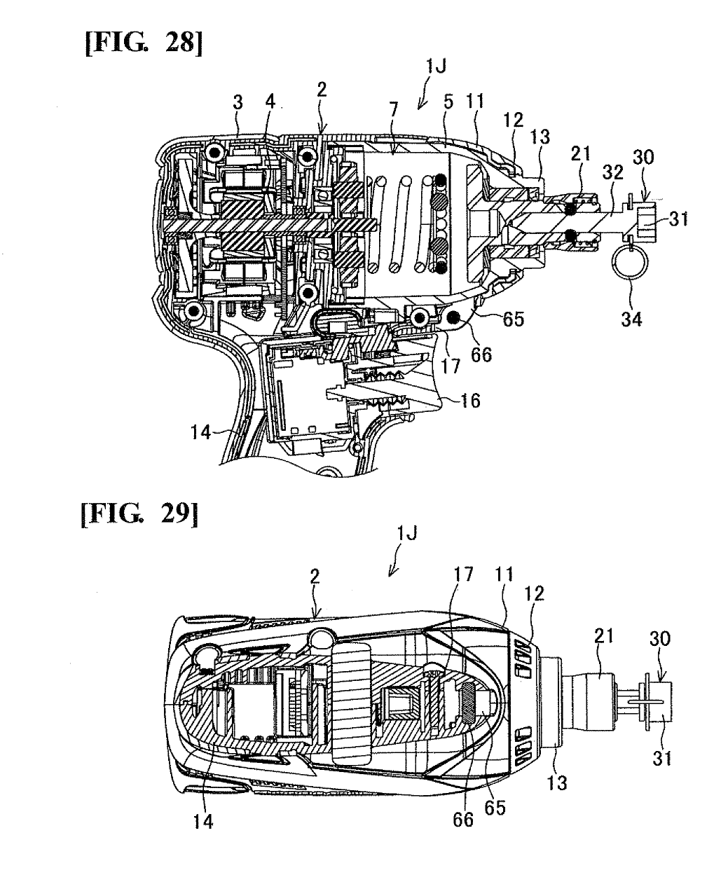

In an impact driver 1J shown in FIGS. 27 to 29, the screw boss is not used. Instead, a pin 66 serving as the connecting portion extends across the front end of the extension portion 17 formed with the cutout 65 such that an intermediate portion thereof is exposed around its entire periphery. Likewise in this case, the carabiner 35 can be engaged directly with the pin 66.

Hence, when the carabiner 35 is engaged between the ring 34 of the socket 30 and the pin 66, the socket portion 31 is connected to the pin 66 via the carabiner 35. Therefore, the socket portion 31 does not fall off the impact driver 1J even when the bit portion 32 is broken during a tightening operation of a bolt or a nut.

By providing the pin 66, to which the carabiner 35 is connected, integrally with the impact driver 1J in the falling prevention structure according to the tenth embodiment, the labor involved in attaching and detaching a connecting member can be eliminated, similarly to the sixth embodiment. As a result, the socket 30 can be prevented from falling off easily. Further, the compactness of the impact driver 1I is not impaired and the pin 66 is not likely to cause an obstruction or catch on the surroundings. As a result, favorable comfort and ease of use can be maintained.

Moreover, the connecting portion is formed from a shaft (the pin 66) to which the carabiner 35 is engaged, and therefore an improvement in reliability is achieved when the carabiner 35 is engaged.

It should be noted that in the tenth embodiment, it is effective to position the pin in the extension portion, but the position of the pin is not limited thereto, and instead, grooves may be provided newly in the side face or the upper surface of the housing such that the pin extends between inner surfaces of the grooves, or conversely, protrusions may be formed such that the pin extends between the protrusions.

### Eleventh Embodiment

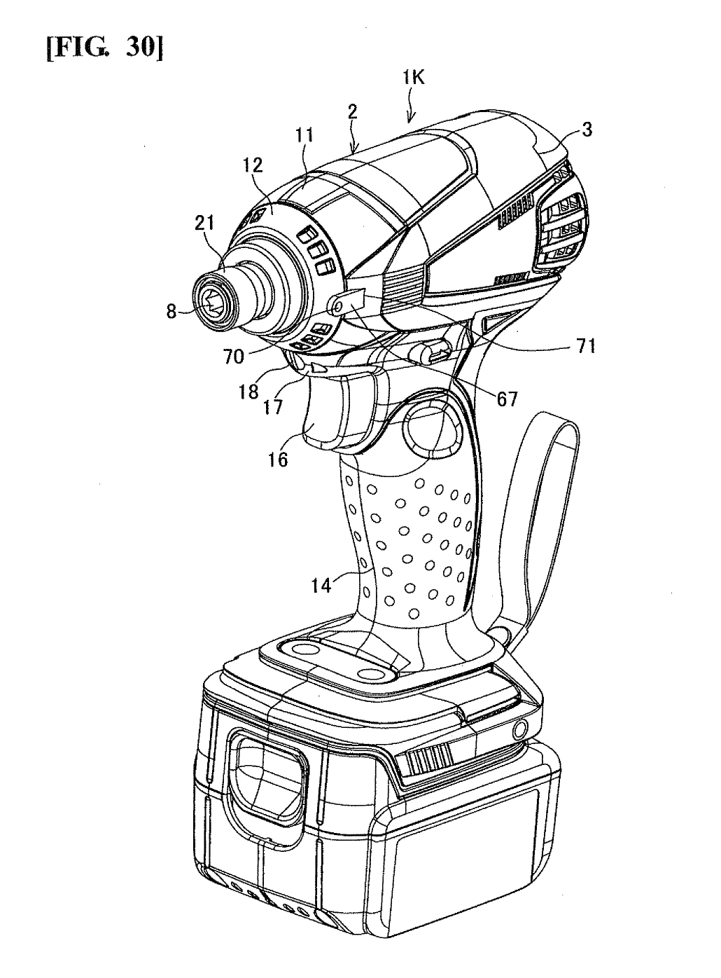

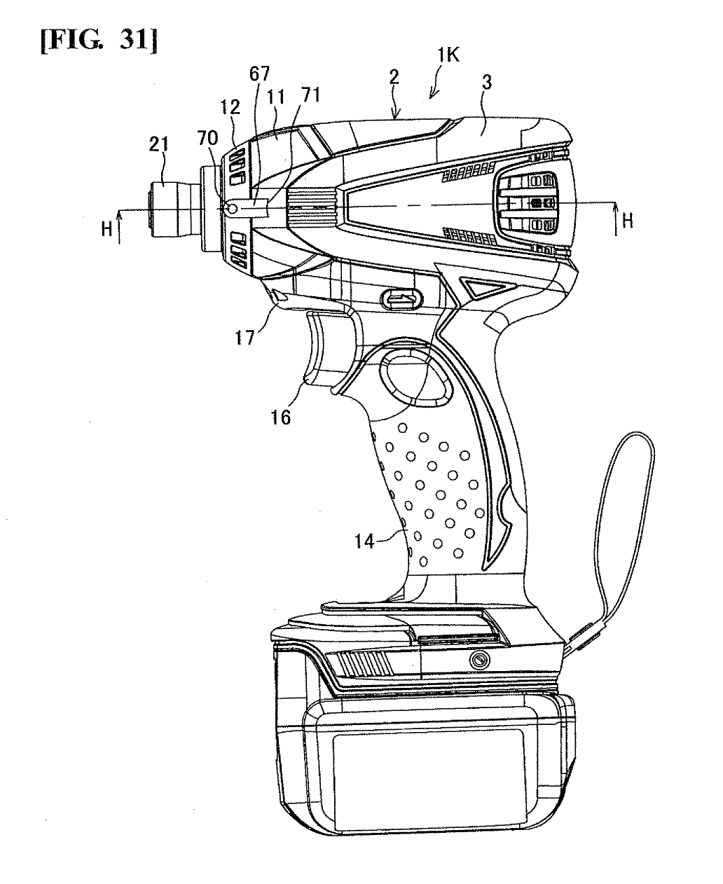

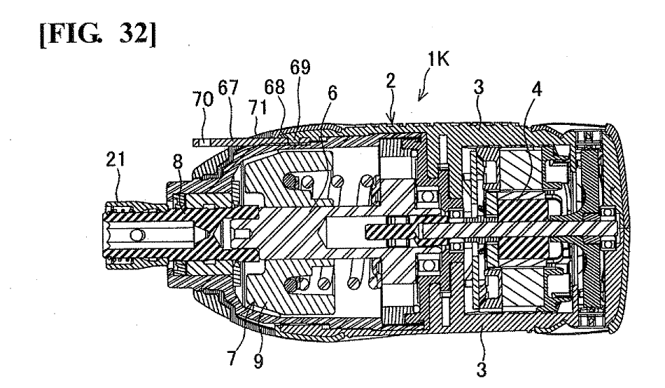

In an impact driver 1K shown in FIGS. 30 to 32, a connecting plate 67 is provided between the hammer case 5 on a right side surface and the main body housing 2 covering a rear portion of the hammer case 5. A rear end of the connecting plate 67 having an engaging hole 68 is inserted between the hammer case 5 which is formed with a chamfered side face, and the main body housing 2, and a protrusion 69 provided on an inner surface of the front end of the main body housing 2 is engaged with the engaging hole 68, so that the connecting plate 67 is sandwiched between the hammer case 5 and the main body housing 2. A front end of the connecting plate 67 includes a through hole 70 serving as the connecting portion, and penetrates a through hole 71 provided in the cover 11 so as to project forward.

Hence, when the carabiner 35 is engaged between the ring 34 of the socket 30 and the through hole 70 in the connecting plate 67, the socket portion 31 is connected to the connecting plate 67 via the carabiner 35. Therefore, the socket portion 31 does not fall off the impact driver 1K even when the bit portion 32 is broken during a tightening operation of a bolt or a nut.

By providing the connecting plate 67 having the through hole 70, to which the carabiner 35 is connected, integrally with the impact driver 1K in the falling prevention structure according to the eleventh embodiment, the labor involved in attaching and detaching a connecting member can be eliminated, similarly to the sixth embodiment. As a result, the socket 30 can be prevented from falling off easily. Further, the compactness of the impact driver 1K is not impaired and the connecting plate 67 is not likely to cause an obstruction or catch on the surroundings. As a result, favorable comfort and ease of use can be maintained. Furthermore, by using the through hole 70 as the connecting portion, an improvement in the reliability of falling prevention can be obtained in a similar manner to the sixth embodiment.

It should be noted that here in particular, the connecting plate 67 is incorporated into the impact driver 1K as a separate body. Therefore, the degree of freedom in the material of the connecting plate 67, the form of the through hole 70, and so on can be improved. Accordingly, the connecting portion that is most suitable for the impact driver 1K can be selected.

In the eleventh embodiment, the length of the connecting plate, the size of the through hole, and so on may be modified appropriately. The connecting plate may be positioned on an opposite side face of the impact driver, and also on the lower surface side or the upper surface side of the housing. Further, the connecting plate may be provided so that it can be inserted into and removed from the housing.

### Twelfth Embodiment

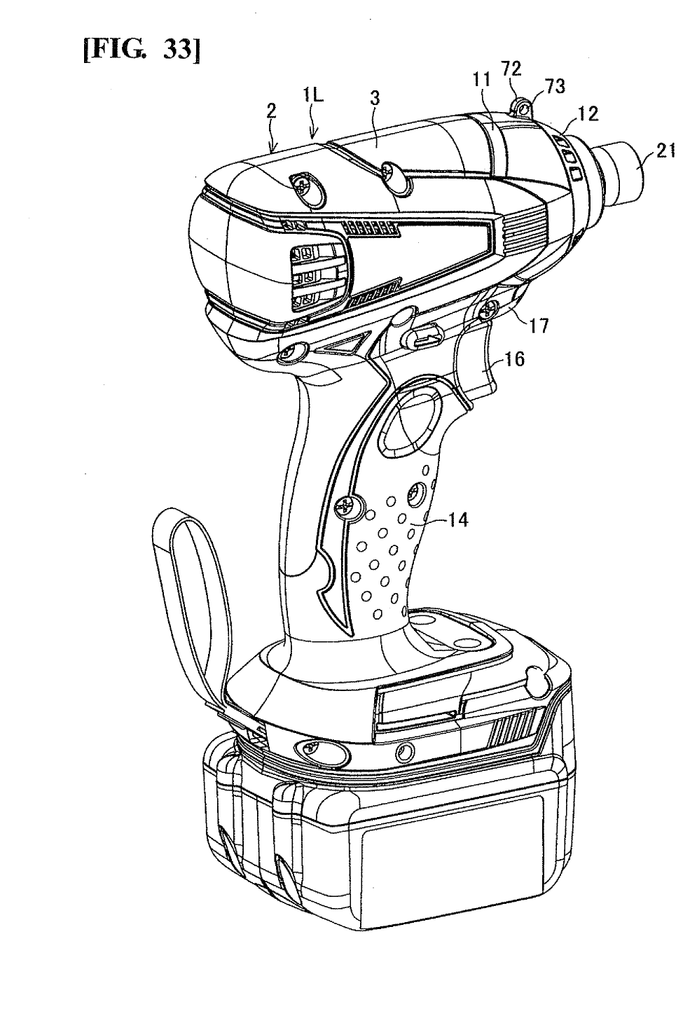

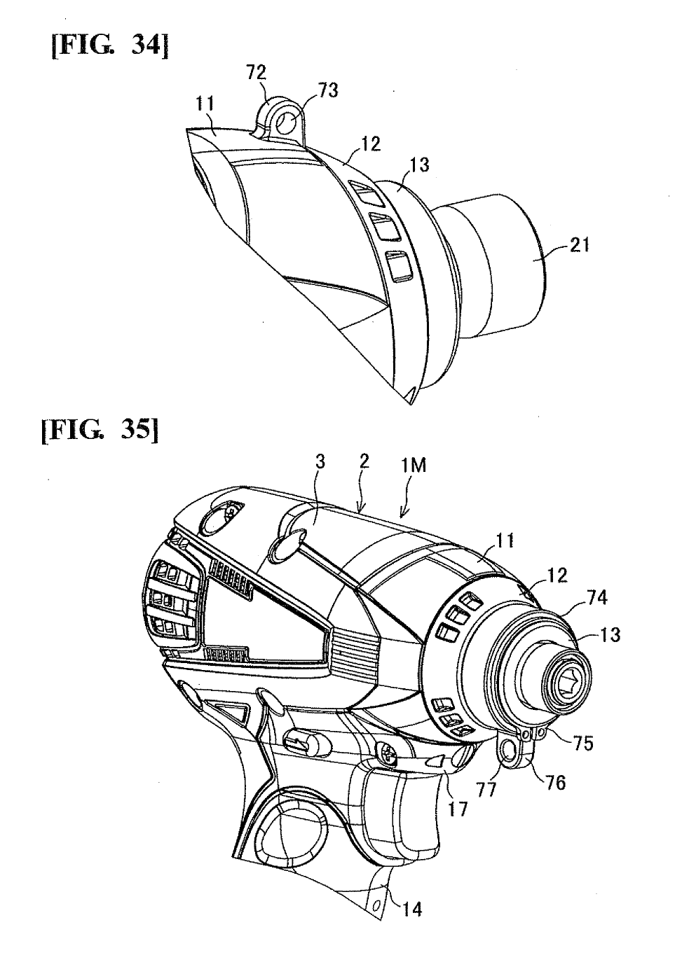

In an impact driver 1L shown in FIGS. 33 and 34, a connecting protrusion 72 having a through hole 73 that serves as the connecting portion is formed integrally with the front end of the upper surface of the cover 11.

Hence, when the carabiner 35 is engaged between the ring 34 of the socket 30 and the through hole 73 in the connecting protrusion 72, the socket portion 31 is connected to the connecting protrusion 72 via the carabiner 35. Therefore, the socket portion 31 does not fall off the impact driver 1L even when the bit portion 32 is broken during a tightening operation of a bolt or a nut.

By providing the connecting protrusion 72 having the through hole 73, to which the carabiner 35 is connected, integrally with the impact driver IL in the falling prevention structure according to the twelfth embodiment, the labor involved in attaching and detaching a connecting member can be eliminated, similarly to the twelfth embodiment. As a result, the socket 30 can be prevented from falling off easily. Further, the compactness of the impact driver 1L is not impaired and the connecting protrusion 72 is not likely to cause an obstruction or catch on the surroundings. As a result, favorable comfort and ease of use can be maintained. Furthermore, by using the through hole 73 as the connecting portion, an improvement in the reliability of falling prevention can be obtained in a similar manner to the sixth embodiment.

It should be noted that in the twelfth embodiment, the shape of the connecting protrusion and the size and orientation of the through hole may be modified appropriately. Further, the connecting protrusion may be disposed on the side face or lower surface side of the cover or formed integrally with the shaft support portion or the extension portion rather than the cover.

### Thirteenth Embodiment

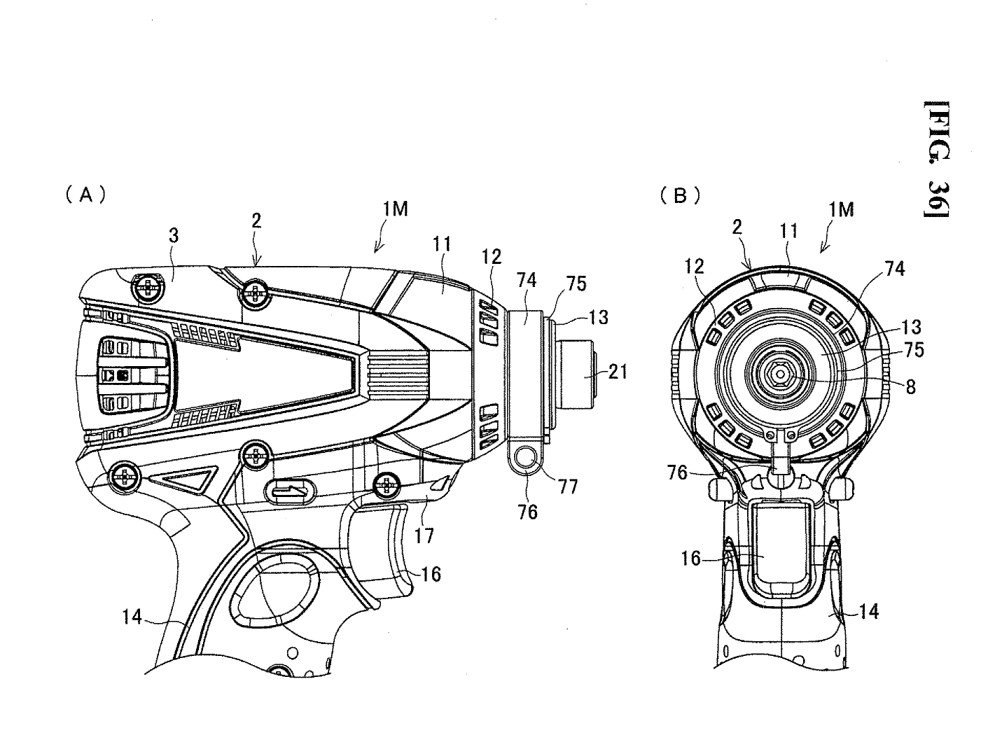

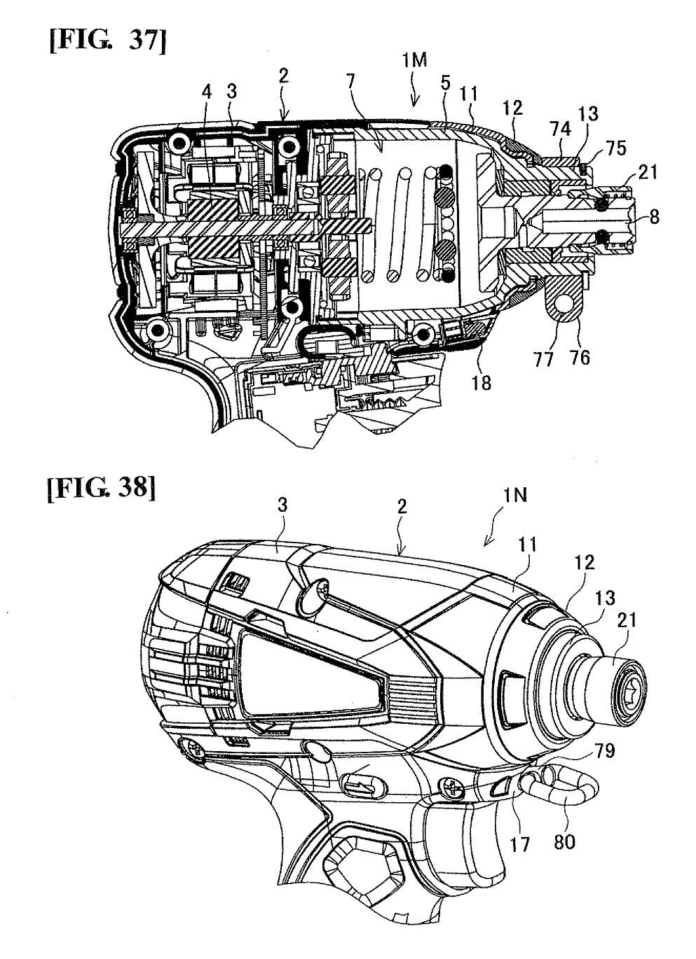

In an impact driver 1M shown in FIGS. 35 to 37, the shaft support portion 13 of the hammer case 5 is increased in length in a forward direction, a connecting ring 74 is externally mounted on the outer periphery of the shaft support portion 13 in front of the bumper 12, and the connecting ring 74 is retained by a retaining ring 75 engaged with the front end of the shaft support portion 13. A protrusion 76 formed with a through hole 77 that serves as the connecting portion is provided to project downward from an outer surface of a lower end of the connecting ring 74.

Hence, when the carabiner 35 is engaged between the ring 34 of the socket 30 and the through hole 77 in the protrusion 76, the socket portion 31 is connected to the connecting ring 74 via the carabiner 35. Therefore, the socket portion 31 does not fall off the impact driver 1M even when the bit portion 32 is broken during a tightening operation of a bolt or a nut.

By providing the connecting ring 74 having the through hole 77, to which the carabiner 35 is connected, integrally with the impact driver 1M in the falling prevention structure according to the thirteenth embodiment, the labor involved in attaching and detaching a connecting member can be eliminated, similarly to the sixth embodiment. As a result, the socket 30 can be prevented from falling off easily. Further, the compactness of the impact driver 1M is not impaired and the connecting ring 74 is not likely to cause an obstruction or catch on the surroundings. As a result, favorable comfort and ease of use can be maintained. Furthermore, similar effects to those of the embodiments described above, namely an improvement in the reliability of falling prevention by using the through hole 77 as the connecting portion, and an increase in the degree of freedom of the form and so on by providing the connecting ring 74 as a separate body, can be obtained.

It should be noted that in the thirteenth embodiment, the form of the protrusion and the size and orientation of the through hole may be modified appropriately. Further, the protrusion may be installed so as to project laterally or upward rather than downward.

### Fourteenth Embodiment

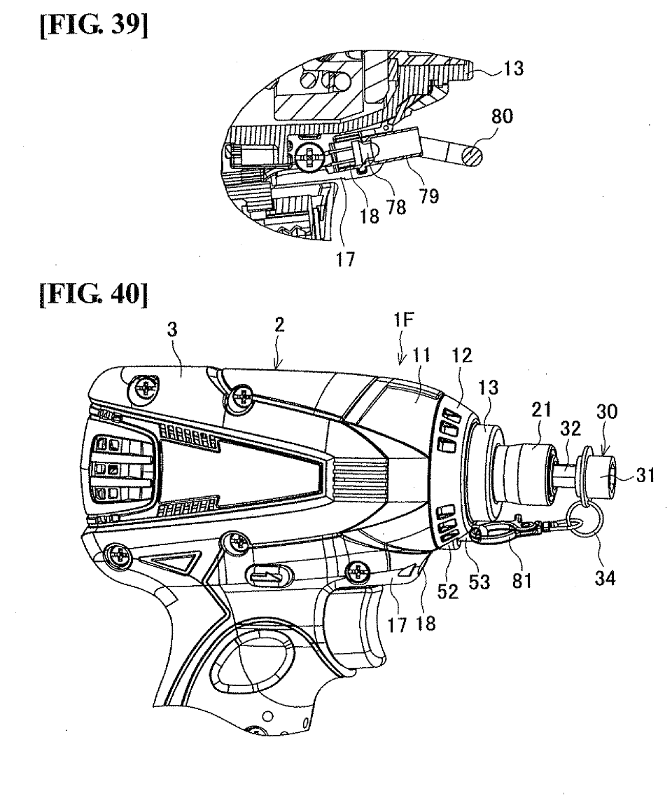

In an impact driver 1N shown in FIGS. 38 and 39, an outer tube 79 of an LED 78 provided in the light unit 18 is formed to be long in a forward direction so as to project forward from the light unit 18. Respective ends of a U-shaped connecting ring 80 are connected to left and right sides faces of the outer tube 79. It should be noted that the connecting ring 80 is fixed in a forward and downward inclined attitude to ensure that light emitted in a forward and upward orientation from the inner tube 79 is not blocked.

Hence, when the carabiner 35 is engaged between the ring 34 of the socket 30 and the connecting ring 80, the socket portion 31 is connected to the connecting ring 80 via the carabiner 35. Therefore, the socket portion 31 does not fall off the impact driver 1N even when the bit portion 32 is broken during a tightening operation of a bolt or a nut.

By providing the connecting ring 80, to which the carabiner 35 is connected, integrally with the impact driver 1N in the falling prevention structure according to the fourteenth embodiment, the labor involved in attaching and detaching a connecting member can be eliminated, similarly to the sixth embodiment. As a result, the socket 30 can be prevented from falling off easily. Further, the compactness of the impact driver 1N is not impaired and the connecting ring 80 is not likely to cause an obstruction or catch on the surroundings. As a result, favorable comfort and ease of use can be maintained.

It should be noted that in the fourteenth embodiment, the size and orientation of the connecting ring may be modified appropriately. Further, the connecting ring may be fixed in a downward orientation rather than an inclined attitude or provided to be capable of swinging forward and rearward rather than fixed.

Furthermore, the connecting body may be connected by applying appropriate modifications to all of the fifth to fourteenth embodiments. For example, instead of using a through hole or a shaft as the connecting portion, as described above, the connecting portion may be constituted by a female screw portion provided in the housing, and a screw connected to the connecting body may be screwed into the female screw portion.

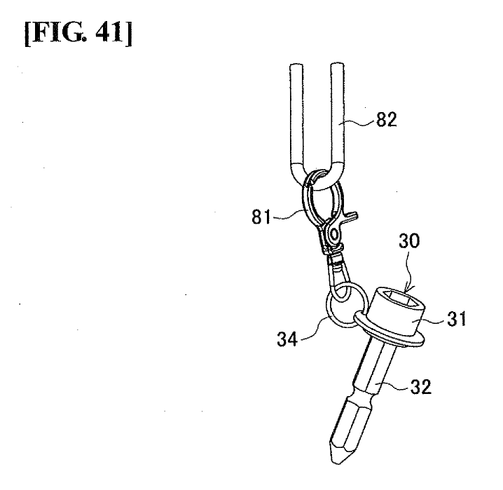

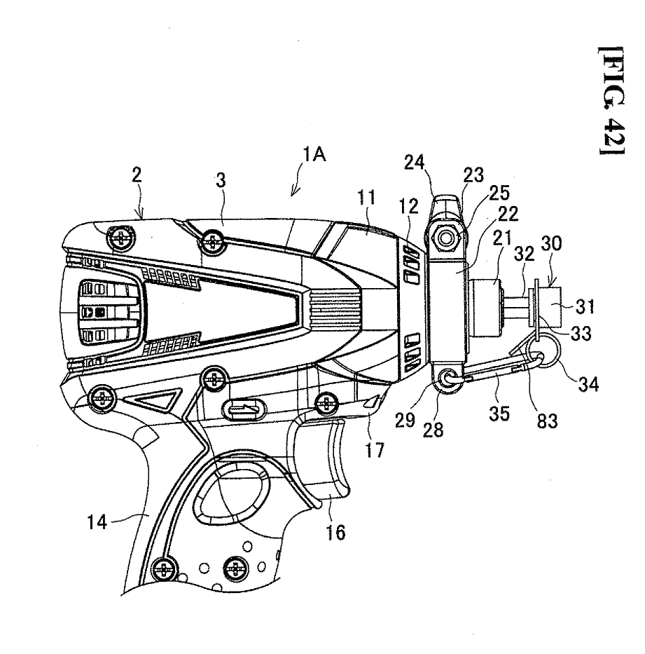

In all of the first to fourteenth embodiments, when the connecting body is constituted by the carabiner alone, the connecting body may be connected to the socket side rather than being attachable to and detachable from both the socket side and the power tool side. FIG. 40 shows an example in which the connecting body is applied to the impact driver 1 F according to the sixth embodiment, in which a base end of a loop clutch 81 serving as the connecting body is connected to the ring 34 of the socket 30 so as to be integrated with the socket 30. When the socket 30 is not in use, as shown in FIG. 41, the socket 30 can hang down alone from an engaging body 82 such as a belt or a hook using the loop clutch 81. It should be noted that this type of connecting body is not limited to a loop clutch, and another hook member such as a snap hook or a key ring may be used. Alternatively, a string-form body such as a chain or a wire may be used to form the connection with the socket.

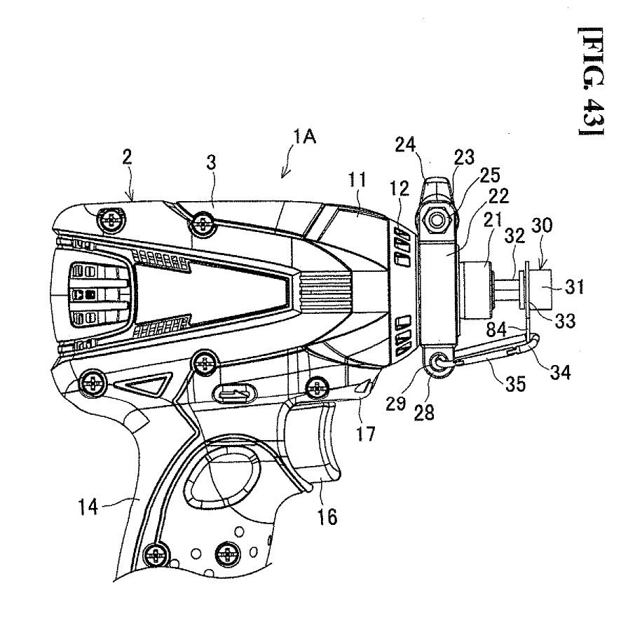

Further, depending on the length of the connecting body, the connection structure with the socket side, and so on, the connecting body may contact the socket or the output shaft of the power tool. When the output shaft is rotated in this state of contact, the connecting body may be spun together with the output shaft so as to be removed from the socket or damaged. To prevent this, restricting unit for preventing the connecting body from contacting the socket and the output shaft is preferably provided. As shown in FIG. 42, in which the restricting unit is applied to the impact driver 1A according to the first embodiment, a restricting plate 83 that protrudes between the socket 30 and the carabiner 35 to prevent the ring 34 and the carabiner 35 from moving to the socket 30 side may be formed integrally with the non-rotating connecting plate 33, for example. Alternatively, as shown in FIG. 43, a structure for securing a large distance between the connecting body and the socket may be realized by providing a part of the connecting plate 33 to project in a radial direction and connecting the carabiner 35 to a tip end of a resulting projecting portion 84.

In the first to fourteenth embodiments, the socket is described as being provided integrally with the bit portion, but the present invention may be applied similarly to a type in which a separate bit can be attached to and detached from the socket portion.

Further, the striking mechanism may employ an oil unit rather than a hammer or the like. Moreover, the power tool is not limited to an impact driver and may be another model such as an angled impact driver. Needless to mention, the present invention may also be applied to an AC tool.

### REFERENCE SIGNS LIST

1A to 1N IMPACT DRIVER

2 MAIN BODY HOUSING

4 MOTOR

5 HAMMER CASE

6 SPINDLE

7 STRIKING MECHANISM

8 ANVIL

9 HAMMER

11 COVER

12 BUMPER

13 SHAFT SUPPORT PORTION

14 HANDLE

17 EXTENSION PORTION

18 LIGHT UNIT

22, 36, 40, 74, 80 CONNECTING RING

23 CLAMP PIECE

24 WING BOLT

26 RIDGE

27, 42 RECESSED GROOVE

28, 45 PROTRUSION

29, 46 PROTRUSION

30 SOCKET

31 SOCKET PORTION

32 BIT PORTION

34 RING

35 CARABINER

37 FEMALE SCREW PORTION

38 MALE SCREW PORTION

44 PROTECTOR

47 CONNECTING BAND

53 CONNECTING PIN

54, 59, 61, 70, 73, 77 THROUGH HOLE

56 CONNECTING BLOCK

60, 72 CONNECTING PROTRUSION

63 SCREW BOSS

66 PIN

67 CONNECTING PLATE

1-12. (canceled)

13. A falling prevention structure for a tip end tool of a power tool, comprising:
a power tool having an output shaft that protrudes from a housing;
a tip end tool attached detachably to the output shaft; and
a connecting body that connects the power tool and the tip end tool to each other so as to prevent the tip end tool from falling, wherein
a connecting member to which the connecting body can be connected is provided so as to be attached to and detached from the power tool.

14. The falling prevention structure for a tip end tool of a power tool according to claim 13, wherein
the connecting member is formed in a ring shape which has a connecting portion to which the connecting body is connected on an outer periphery of the connecting member.

15. The falling prevention structure for a tip end tool of a power tool according to claim 13, wherein
the connecting body includes at least a hook member on an end portion of the connecting member, and is connected to the connecting member by allowing the hook member to pass through and engage with the connecting member.

16. The falling prevention structure for a tip end tool of a power tool according to claim 14, wherein
the connecting body includes at least a hook member on an end portion of the connecting member, and is connected to the connecting member by allowing the hook member to pass through and engage with the connecting member.

17. The falling prevention structure for a tip end tool of a power tool according to claim 13, wherein
the connecting member is provided on an outer periphery of a tubular shaft support portion that is formed on a front end of the housing to support the output shaft rotatably.

18. The falling prevention structure for a tip end tool of a power tool according to claim 14, wherein
the connecting member is provided on an outer periphery of a tubular shaft support portion that is formed on a front end of the housing to support the output shaft rotatably.

19. The falling prevention structure for a tip end tool of a power tool according to claim 14, wherein
the connecting member is provided such that an attachment position of the connecting member in a circumferential direction can be modified.

20. The falling prevention structure for a tip end tool of a power tool according to claim 14, wherein
the connecting member is a connecting ring, a part of which is separated such that respective ends of the connecting ring form a pair of clamp pieces having a predetermined interval, and
the connecting ring can be attached and detached by rotating a wing bolt penetrating one of the clamp pieces so that the wing bolt is screwed to a nut fitted to the other clamp piece.

21. The falling prevention structure for a tip end tool of a power tool according to claim 20, wherein
a ridge is provided around an inner periphery of the connecting ring in a circumferential direction, and
a recessed groove into which the ridge fits is provided in a mounting position in which the connecting ring is mounted on the power tool.

22. The falling prevention structure for a tip end tool of a power tool according to claim 14, wherein
the connecting portion is a protrusion in which a through hole is formed.

23. The falling prevention structure for a tip end tool of a power tool according to claim 14, wherein
the connecting member is a connecting ring which has a female screw portion formed in an inner periphery of the connecting ring and is mounted by screwing the female screw portion to a male screw portion provided on the power tool.

24. The falling prevention structure for a tip end tool of a power tool according to claim 23, wherein
a plurality of teeth is formed continuously on an outer periphery of the connecting ring.

25. The falling prevention structure for a tip end tool of a power tool according to claim 14, wherein
a protrusion is provided on one of an inner peripheral surface of the connecting member and an outer peripheral surface of the power tool, and
an introduction groove into which the protrusion goes as the connecting member is mounted and a circumferential recessed groove that communicates with the introduction groove are provided on the other one of the inner peripheral surface of the connecting member and the outer peripheral surface of the power tool, whereby
the connecting member can be attached to and detached from the power tool by a bayonet joint.

26. The falling prevention structure for a tip end tool of a power tool according to claim 13, wherein
a protector is mounted so as to be attached to and detached from the power tool, and
a connecting portion in which the connecting body is connected to is provided on the protector such that the protector doubles as the connecting member.

27. A power tool having the falling prevention structure for a tip end tool according to claim 13.

28. A connecting structure capable of connecting a tip end tool of a power tool to a housing of the power tool, wherein
the connecting structure has a connecting member fixed to the housing, and
the connecting member is fixed to the housing by a screw.

29. A power tool having the connecting structure according to claim 28.

30. A connecting body capable of being connected to a metallic hammer case of an electric impact driver, wherein
the connecting body is capable of being connected to a tip end tool attached detachably to an output shaft of the electric impact driver.

31. A power tool comprising the connecting body according to claim 30.
